(19) United States
(12) Patent Application Publication
(10) Pub. No.: US 2003/0009346 A1
(43) Pub. Date: Jan. 9, 2003

(54) Method of setting direction of growing personnel, method of selecting supplementary capability, method of selecting supplementary personnel, method of evaluating personnel, system of forming personnel fostering plan, personnel supplementing system, business achievement assessing system and information transmitting medium

(76) Inventor: Atsushi Shimizu, Shimogyo-ku (JP)

Correspondence Address: ROSENTHAL & OSHA L.L.P., 1221 MCKINNEY AVENUE, SUITE 2800, HOUSTON, TX, 77010, US

(21) Appl. No.: 09/885,296

(22) Filed: Jun. 20, 2001

(30) Foreign Application Priority Data
Jun. 20, 2000 (JP) 2000-185287

(51) Int. Cl. G06F 17/60

(52) U.S. Cl. 705/1; 705/7

(57) ABSTRACT

To form a personnel fostering policy suitable for growing an organization in a direction of realizing a future conception, information with regard to a current mission and a future vision of an organization is inputted to thereby deduce capabilities necessary for the organization at present and in the future and a current capability and a future image of respective personnel in the organization are inputted to thereby deduce capability data for the respective personnel. Further, with regard to the capabilities necessary for the organization at present and in the future, a capability amount for respective personnel is accumulated for respective kind of capability to thereby deduce a capability amount of the organization, thereafter, the capability amount of the organization is compared with a capability amount necessary for the organization to thereby sample an excess or deficient state of the capability of the organization. Further, a direction of individually growing the respective personnel is set based on strong point/weak point data provided from the capability data and the excess or deficient state of the capability of the organization.

### BACKGROUND OF THE INVENTION

1. Field of the Invention

The present invention relates to fostering and supplementing respective personnel in an organization and evaluation of personnel in an organization. Specifically, the invention relates to fields of personnel control, personnel education, organization management, personnel dispatchment, personnel introduction, assessment of business achievement of respective personnel and the like.

2. Description of the Related Art

In an organization such as “department” or “section” in an enterprise, generally, there is determined business which is executed in the organization by “mission (task, duty)” given to the organization. A mission is determined based on a business scheme of an organization in a predetermined period of time and there are determined kinds of business (normally, a plurality of kinds of business are set) to be executed by the organization in the predetermined period of time or in a portion of the period and targets for achieving the respective business. The respective business is allocated to respective personnel in the organization as “business in charge” and the respective personnel is given targets or problems in executing the business in charge based on the mission.

In an organization, normally, there is periodically assessed a degree of achieving business in charge of respective personnel in the organization. Generally, the assessment is carried out by checking assessment items in accordance with business by a personnel per se or a superior and outputting an evaluation mark in accordance with the result. Further, an organization or a control department such as a personnel department carries out education with regard to current business in charge as necessary, recognizes intention and aptitude of a personnel by using an interview with the personnel or the assessment result and determines a fostering policy in the future.

Meanwhile, in order to execute a mission given to an organization, it is necessary to sufficiently ensure personnel each having a capability of being in charge of the respective business. In other words, when there is not a personnel capable of being in charge of business with regard to predetermined business or when a number of personnel of executing business in accordance with a target is deficient, it is impossible to execute the mission by the current capability of the organization.

In such a case, in order to execute the mission, it is necessary for the organization to take a measure of supplementing new personnel or assigning a portion of the business to outside.

When personnel are supplemented, there are a method of introducing necessary personnel from a recruiting company and a method of receiving dispatchment of personnel from a personnel dispatching company other than a method of directly recruiting by the organization or a higher organization (personnel department or the like).

In the case of assigning business to outside, when the business is business having high specialty, there is selected an individual or a specialized company having expertise specific to the business. Meanwhile, when the business is supporting business requiring productivity such as processing of voucher or general affairs, there is selected a method of offering necessary business service to a supporting company providing such business as a packaged service.

FIG. 53 shows a specific example of business content of an outsourcing company contracting business having high specialty and FIG. 54 shows a specific example of business content of outsourcing by a specialized supporting company, respectively.

It is a final prime object of business assessment or personnel fostering in a conventional organization whether individual personnel can achieve given business targets. Although a capable controller or a person in charge of personnel affair, can take a role achieved by a personnel for achieving a business which is not apt for an organization into consideration or designate an effort target of respective personnel for growing a total of the organization, heretofore, the controller or the person in charge of personnel affair simply faces individual personnel and does not face individual personnel in the organization, which is a problem. Further, knowhow for such assessment or personnel fostering significantly depends on experience or perception of individual and cannot be formed into a manual.

Therefore, in many cases, respective personnel in an organization is brought into a state in which the personnel is evaluated by capability at current time or past business achievement, only allocated with business in charge, is not supplemented with capability deficient for the organization and is not sufficiently informed of what role the personnel is to bear in order to realize the policy of growing the organization or what capability needs to promote in the future in order to grow the organization. Therefore, there is a concern that the personnel is embedded in daily business and loses work motivation and efficiency of executing business is deteriorated.

Further, conventionally, when an organization utilizes a system of personnel dispatchment or business assignment, importance is given only to executing a mission given at the current time, deficient personnel or capability is supplemented only temporarily and it is extremely difficult to supplement deficient capability by analyzing a state of holding capability in the organization in details or to supplement a personnel guiding the organization in a growing direction.

For example, as shown by FIG. 55, a conventional personnel dispatching company is classified in two of a department store type put in together personnel having various capabilities and a specialized type gathering personnel thoroughly acquainted with specialized fields and in either of the modes, a personnel to meet request of a client organization, is simply dispatched and there is not brought about a processing of selecting a personnel sufficiently supplementing capability deficient for the organization or selecting a dispatch personnel optimum for achieving future target of the organization.

### SUMMARY OF THE INVENTION

It is a first object of the invention to derive a personnel fostering policy for promoting a capability necessary for executing a mission of an organization in capabilities provided to a respective personnel with regard to the respective personnel in the organization without depending on experience or perception of individual.

Further, it is a second object of the invention to derive a personnel fostering policy suitable for growing an organization in a direction of realizing a future conception without depending on experience or perception of individual.

Further, it is a third object of the invention to sample a capability deficient in executing a mission given to an organization when a personnel is supplemented to the organization and to select a supplementary personnel or a business service optimum for resolving the state of being deficient of the capability.

Further, it is a fourth object of the invention not only to supplement a deficiency of a capability in a current organization but also to select a supplementary personnel or a business service necessary in a procedure of growing an organization and a personnel while showing a plan of fostering a personnel for growing a total of the organization in line with a future conception to the organization.

Further, it is a fifth object of the invention to support organizations in changing a position or changing a job of a personnel between the organizations such that a supplementary personnel who can hold a capability necessary for executing a given mission, is arranged to the organization suitable for the capability of the personnel per se.

Further, it is a sixth object of the invention to support an organization in changing a position or changing a job of a personnel such that a supplementary personnel who is optimum in executing a current mission of the organization and realizing a future conception thereof, is arranged to the organization suitable for a capability of the personnel per se and a future image thereof and can grow in an ideal direction along with the organization.

In addition thereto, it is a seventh object of the invention to provide a system capable of properly evaluating a role achieved by a respective personnel in executing a business by an organization by carrying out an assessment added with an excess or deficient state of a capability of the organization when forming assessment information of business achievement of the personnel in the organization.

“Organization” mentioned in the invention refers to a society to which a plurality of personnel belong and which makes an action for achieving a common mission. For example, in a company, there are present organization of various units such as a division, a department, a section, a subsection, a sub group or a total of the company. In many cases, there is set a hierarchy relationship in which a higher organization includes a plurality of lower organizations among the organizations and a mission of a lower organization is determined based on a mission in a higher organization.

Further, a mission indicates a role to be achieved by an organization in a predetermined period of, for example, one month, half a year or a year and includes information such as a kind of business to be executed by the organization and a target to be achieved by respective business in a period of time.

“Capability” described in the invention is represented by a combination of information representing a kind or a content of capability (for example, reading capability, document forming capability or linguistic capability) and information (capability amount) indicating degree of highness of the capability. The capability amount is indicated by an evaluation mark (100 point, 80 point, 60 point) of, for example, a highness of a capability of a personnel based on predetermined criteria or character information (A rank, B rank, C rank) indicating the highness of the capability as levels.

According to an aspect of the invention specified by claim 1, there is provided a method of setting a direction of growing a personnel which is a method of setting a direction of growing a personnel necessary for forming a plan of fostering the personnel in an organization, the method comprising the steps of receiving information with regard to a mission of the organization and thereafter deducing a capability necessary for the organization by using the information, receiving information with regard to a capability of the respective personnel in the organization and thereafter deducing a capability held by the organization by using the information, and sampling an excess or deficient state of the capability in the organization by comparing a necessary amount of the capability with a capability amount held by the organization for a respective kind of the capability necessary for the organization and thereafter individually setting the direction of growing the respective personnel from the information with regard to the capability of the respective personnel based on a result of sampling thereof.

As described above, “mission of organization” indicates business of an organization and achieving objects thereof in a predetermined period of time and is normally represented by an aggregation of information with regard to a plurality of kinds of business. That is, “information with regard to mission of organization” can be formed in a pattern as a combination of kinds of business and business targets for respective business executed by the organization.

Further, “information with regard to a mission of an organization” according to the aspect of the invention specified by claim 1, may indicate information showing a mission given to the organization at present or may indicate information showing a mission having a possibility of being given to the organization in the future.

Further, the information may include both of information indicating a mission at present and information indicating a mission in the future. The reason is that even when received information is assumedly information based on a business scheme of a short term, in the case in which the business scheme is established under business schemes of a middle term and a long term, other than information with regard to a mission given to the organization at present, there is included information with regard to a mission of the organization in the future. The same goes with aspects of the invention specified by claims 3, 6, 9, 12, 15, 20, 21 and 22 as follows.

“Capability necessary for organization” indicates a capability necessary for executing respective business included in a mission of an organization in accordance with an achieving target thereof. Normally, there are needed a plurality of kinds of capabilities in executing single business and same capability may commonly be required for a plurality of business. “Capability necessary for organization” is a concept integrating conditions of respective business included in a mission of an organization and can be represented by an aggregation of capability information (refer to a combination of kinds of capabilities and capability amounts, mentioned above) necessary for business to be executed by the organization.

“Information with regard to capability of respective personnel in organization” is capability information with regard to a capability held by an individual personnel and can be derived from a result of a questionnaire to a personnel per se or a superior or a result of a capability test or an aptitude test to the personnel.

Further, also with regard to the capability information, there is a case of indicating a capability held by a respective personnel at present and there is a case of indicating a capability having a possibility of being held by the respective personnel in the future. Further, there also is the case of including both of information at present and in the futures (The definition applies similarly also to aspects specified by claims 3, 6, 9, 12, 15, 20, 21 and 22 as follows)

“Necessary amount of capability (necessary for organization)” refers to a capability amount required for a various capability necessary in executing a mission by an organization.

“Excess or deficient state of capability in organization” sampled by comparing “necessary amount of capability necessary for organization” with “capability amount held by organization”, indicates whether an organization sufficiently holds a capability necessary in executing a mission and can specifically be indicated by a combination of kinds of capabilities necessary for the organization and numerical information indicating degrees of excess or deficiency of the capability amount. However, the numerical information is not necessarily needed but only a kind of an excessive or deficient capability may be shown. Further, there may be set information indicating degrees of excess or deficiency of a capability amount by a plurality of stages such as “significantly deficient”, “rather deficient”, “not excessive and not deficient”, “rather excessive” and “significantly excessive” and corresponding information may be selected.

Further, “capability amount held by the organization” can be deduced by accumulating capability amounts held by respective personnel with regard to capabilities necessary for a mission for respective kinds of capabilities.

Further, “direction of growing respective personnel” is information indicating a target inherent to a respective personnel and is indicated by a kind of a capability to be promoted by a personnel and numerical information indicating a degree of promoting a capability amount thereof.

According to another aspect of the invention specified by claim 2, there is provided a method of setting a direction of growing a personnel which is a method of setting a direction of growing a personnel necessary for forming a plan of fostering the personnel, the method comprising the steps of receiving information with regard to a current mission of the organization and a mission having a possibility of being given to the organization in the future and thereafter deducing capabilities necessary for the organization at present and in the future by using the information, receiving information with regard to a capability and a future image of the respective personnel in the organization and thereafter deducing a capability held by the organization at present and a capability having a possibility of being held by the organization in the future by using the information, and sampling excess or deficient states of the capabilities in the organization by comparing necessary amounts of capabilities with a capability amount held by the organization and a capability amount having a possibility of being held by the organization in the future for respective kinds of the capabilities necessary for the organization at present and in the future and thereafter individually setting the direction of growing the respective personnel from the information with regard to the capability and the future image of the respective personnel based on a result of sampling thereof.

“Capabilities necessary for organization at present and in the future” refers to capabilities necessary for executing respective business included in missions of the organization at present and in the future in accordance with achieving objects thereof and can be represented by an aggregation of capability information (refers to a combination of kinds of capabilities and capability amounts) necessary for business to be executed by an organization at present and in the future.

“Information with regard to future image” of a respective personnel is information based on effort target, desire or expectation of surrounding of a personnel per se and can be represented by capability information (that is, a combination of kinds of capabilities and capability amounts) with regard to capabilities having possibilities of being held by the personnel in the future.

“Capability amount having possibility of being held by organization in the future” can be deduced by accumulating capability amounts having possibilities of being held by respective personnel in the future for respective kinds of capabilities.

Further, the definitions of the above-described “information with regard to future image” and “capability amount having possibility of being held by organization in the future”, apply to aspects of the invention specified by claims 4, 7, 10, 13 and 16, described later.

In the aspects of the invention specified by claims 1 and 2, following combinations are conceivable in comparing processings for sampling an excess or deficiency state of a capability.

First, by comparing “necessary amount of capability necessary for organization at present” with “capability amount held by the organization at present”, there is sampled an excess or deficient state of a capability of an organization at present and by comparing “necessary amount of capability necessary for organization in the future” with “capability amount having possibility of being held by organization in the future”, there is sampled an excess or deficient state of a capability of an organization in the future. Further, by comparing “necessary amount of capability necessary for organization in the future” with “capability amount held by organization at present”, there can be sampled an excess or deficient state of a capability at a current time point with regard to a mission of an organization in the future.

As means for executing the aspect of the invention specified by claim 1, according to another aspect of the invention specified by claim 9, there is provided a system of forming a personnel fostering plan which is a system of forming a personnel fostering plan of a personnel in an organization, the method comprising information inputting means for receiving information with regard to a mission of the organization and information with regard to a capability of a respective personnel belonging to the organization, necessary capability acquiring means for deducing a capability necessary for the organization for the mission by using the input information with regard to the mission of the organization, individual capability acquiring means for deducing the capability held by the respective personnel by using the input information with regard to the respective personnel, capability amount accumulating means for accumulating a capability amount held by the respective personnel with regard to the capability necessary for the organization for respective kind of the capability, sampling means for sampling an excess or deficient state of the capability in the organization by comparing a result of accumulating the capability amount provided by the capability amount accumulating means with a necessary amount of the capability necessary for the organization, growing direction setting means for setting a direction of growing the respective personnel from acquired information by the individual capability acquiring means based on the excess or deficient state of the capability sampled by the sampling means, and plan forming means for forming a fostering plan indicating the direction of growing the respective personnel set by the growing direction setting means for the respective personnel.

As means for executing the aspect of the invention specified by claim 2, according to another aspect of the invention specified by claim 10, there is provided a system of forming a personnel fostering plan which is a system of forming a personnel fostering plan of a personnel in an organization, the system comprising information inputting means for receiving information with regard to a current mission of the organization and a mission having a possibility of being given to the organization in the future and information with regard to a capability and a future image of a respective personnel belonging to the organization, necessary capability acquiring means for deducing capabilities necessary for the organization at present and in the future for the missions by using the input information with regard to the missions of the organization at present and in the future, individual capability acquiring means for deducing a capability held by the respective personnel at present and a capability having a possibility of being held by the respective personnel in the future by using the input information with regard to the respective personnel, capability amount accumulating means for accumulating a capability amount held by the respective personnel at present and a capability amount having a possibility of being held thereby in the future for respective kinds of the capabilities with regard to the capabilities necessary for the organization at present and in the future, sampling means for sampling excess and deficient states of the capabilities in the organization by comparing results of accumulating the capability amounts at present and in the future provided by the capability amount accumulating means with necessary amounts of the capabilities necessary for the organization at present and in the future, growing direction setting means for setting a direction of growing the respective personnel from acquired information by the individual capability acquiring means based on the excess or deficient states of the capabilities sampled by sampling means, and plan forming means for forming a fostering plan indicating the direction of growing the respective personnel set by the growing direction setting means for the respective personnel.

In the aspects of the invention specified by claims 9 and 10, the information inputting means is means for inputting an answer pattern to a questionnaire or a test with regard to information related to a mission of an organization and information related to a capability and a future image of the respective personnel. The information inputting means is constituted by a keyboard when data is manually inputted and is constituted by a drive apparatus exclusive for a predetermined record medium when inputting data recorded on the medium. Further, when data is inputted from a computer on a side of an organization via a network, the information inputting means is constituted by the network and a data receiving circuit.

The data received by the information inputting means is not limited to the above-described answer pattern but with regard to information related to a mission, information constituted by a combination of kinds of business and targets of business achievement may be inputted directly and with regard to a capability and a future image of the respective personnel, the above-described capability information, that is, information constituted by a combination of kinds of capabilities and degrees of highness of capability amounts may directly be inputted.

Meanwhile, arbitrary information capable of deriving the answer pattern may be inputted and the answer pattern may be sampled from information inputted to a computer. Particularly when information before being patternized in this way is inputted, there is a case of simultaneously inputting “current mission” and “future mission”. The reason is that a mission in a short term is frequently set based on middle term and long term schemes and information with regard to future mission is included in information inputted as information with regard to present mission.

Further, when the side of the organization directly inputs data by using a keyboard or a network, data can be inputted by a method of successively presenting predetermined questions to the side of the organization by display or voice and answering to the respective questions.

Further, the above-described definition of the information inputting means applies to respective aspects of the invention specified by claims 15, 16, 18 and 19.

According to another aspect of the invention specified by claim 11, there is provided the personnel fostering plan forming system according to claim 9 or 10, further comprising information outputting means for outputting the plan of fostering the personnel formed by the plan forming means to outside.

The information outputting means is aimed at presenting the formed fostering plan to the organization or the respective personnel of the organization or both and can be realized by, for example, a printer for printing the fostering plan on a paper medium, a drive apparatus for writing thereof to a predetermined record medium or a network (including a circuit for transmitting data) for outputting electronic data of the fostering plan to the computer on the side of the organization.

According to an aspect of the invention specified by claim 3, similar to the aspect of the invention specified by claim 1, after respectively deducing the capability necessary for the organization and the capability held by the organization from information with regard to mission of the organization and information with regard to capability of the respective personnel in the organization, for respective kind of the capability necessary for the organization, the necessary amount of the capability is compared with the capability amount held by the organization to thereby sample the excess or deficiency state of the capability in the organization. Further, based on the sampling result, there is sampled data in accordance with a deficient state of the capability in the organization from a data base registered with a supplementary personnel having a predetermined capability or a business service executed by the capability.

Further, according to an aspect of the invention specified by claim 4, after sampling the excess or deficiency state of the capability in the organization and setting the direction of growing the respective personnel by executing steps similar to those of the aspect of the invention specified by claim 2, there is formed and outputted the fostering plan including information indicating the direction of growing the respective personnel. Further, from a data base registered with a supplementary personnel having a predetermined capability or a business service executed by the capability, there is executed a step of sampling data with regard to a capability in accordance with a deficient state of a capability with regard to the current mission and a capability deficient during a time period until the respective personnel in the organization grows in line with the set direction of growing thereof.

A system of supplementing a personnel according to an aspect of the invention specified by claim 12, is a system of selecting a supplementary personnel by the method of the aspect of the invention specified by claim 3, including information inputting means, necessary capability acquiring means, individual capability acquiring means, capability amount accumulating means and sampling means similar to those of the aspect of the invention specified by claim 9 as well as data base registered with a predetermined number of supplementary personnel and personnel sampling means for sampling a personnel having a capability in accordance with a deficient state of a capability of the organization from the data base based on a sampling result by the sampling means.

Further, a system of supplementing a personnel according to an aspect of the invention specified by claim 13, is a system of selecting a supplementary personnel by the method of the aspect of the invention specified by claim 4, including information inputting means, necessary capability acquiring means, individual capability acquiring means, capability amount accumulating means, sampling means and growing direction setting means similar to those in the aspect of the invention specified by claim 10, as well as information outputting means for outputting a personnel fostering plan to outside after forming the personnel fostering plan indicating the direction of growing the respective personnel, a data base registered with a predetermined number of supplementary personnel and personnel sampling means for sampling a personnel having a capability in accordance with a deficient state of a capability in the organization at present and a personnel having a capability deficient during a time period in which the respective personnel in the organization grows in line with the set direction of growing thereof from the data base.

The personnel supplementing system according to the aspect of the invention specified by claim 12 or 13 can be used with the purpose of arranging a newly employed personnel or a temporary personnel (part-timer, student worker) as a supplementary personnel for the organization in a personnel department of an enterprise. Further, the system can also be set as a system for a personnel dispatching service used in the personnel dispatching company.

Further, although it is preferable that the information outputting means in the aspect of the invention specified by claim 13, presents the fostering plan to the organization, a plan inherent to the respective personnel may be presented thereto as necessary. Further, various modes are conceivable to the information outputting means similar to those of the aspect of the invention specified by claim 11.

According to the constitution of the aspect of the invention specified by claim 13, “deficient state of capability in organization at present” constituting a first condition of sampling a personnel from supplementary personnel sampled by the personnel sampling means, is set by comparing “necessary amount of capability necessary for organization at present” with “result of accumulating capability amount held by respective personnel at present” by the sampling means. Further, “capability deficient during a time period until respective personnel in organization grows in line with the direction of growing thereof” constituting a second condition of sampling a personnel, can be set by comparing “necessary amount of capability necessary for organization in the future” with “result of accumulating capability amount held by the respective personnel at present” or “result of accumulating capability amount having possibility of being held by respective personnel in the future”. Further, the second condition of sampling a personnel can be set by determining targets of a plurality of steps between “capability necessary for organization at present” and “capability necessary for organization in the future” as necessary and by excess or deficiency states of capability amounts of the organization with regard to capabilities in accordance with the targets.

Further, particularly when the system according to the aspect of the invention specified by claim 12 or 13 is used in a personnel dispatching service, it is preferable to constitute to form a plan of supplementing a personnel from a result of sampling the supplementary personnel and output thereof to the organization.

According to an aspect of the invention specified by claim 5, there is provided the method of selecting a supplementary capability according to claim 4 wherein after elapse of a predetermined time period from outputting the plan of fostering the personnel, a degree of promoting the capability held by the organization is sampled by using information with regard to the capability of the respective personnel at the time point and a reward sum charged to the organization is determined in accordance with the degree of promoting the capability.

Further, the “degree of promoting capability” signifies the degree of promoting the capability amount of the respective kind of the capability held by the organization. The degree of promoting the capability amount can be represented by numerical information indicating an increase or a decrease in the capability amount. Or, similar to the above-described excess or deficiency states of capability, there may be set information indicating degrees of increase or decrease of the capability amount by a plurality of stages such as “significantly reduced”, “rather reduced” “no change”, “rather increase”, “significantly increased” and corresponding information may be selected.

In order to execute the above-described method, according to an aspect of the invention specified by claim 14, there is provided the system of supplementing a personnel according to claim 13, further comprising accumulated capability amount holding means for holding a result of accumulating the capability amount at present provided by the capability amount accumulating means in a memory, new capability acquiring means for deducing the capability of the respective personnel at a time point after elapse of a predetermined time period since the plan of fostering the personnel has been outputted by using the information inputting means and the individual capability acquiring means, and reward sum determining means for accumulating a capability amount indicated by a new capability of the respective personnel provided by the new capability acquiring means for respective kind of the capability, comparing a result of accumulating the capability amount with the accumulated result held in the memory by the accumulated capability amount holding means and determining a reward sum charged to the organization in accordance with a result of comparing thereof.

Further, the system having the above-described constitution is mainly applied to a personnel dispatching service.

According to an aspect of the invention specified by claim 6, there is provided a method of selecting a supplementary personnel which is method of selecting a personnel supplemented to one organization from other organization, the method comprising the steps of receiving information with regard to missions of respective organizations with regard to a plurality of the organizations and thereafter deducing capabilities necessary for the organizations by using the information, receiving information with regard to respective capabilities of respective personnel belonging to the respective organizations and thereafter deducing capabilities held by the respective organizations by using the information, determining excess or deficient states of the capabilities in the respective organizations by comparing necessary amounts of capabilities necessary for the respective organizations for respective kinds of the capabilities with capability amounts held by the organizations with regard to the respective organizations, and sampling a personnel having a capability in the other organization as a supplementary personnel to the one organization when the capability determined to be deficient in the arbitrary one organization is determined to be excessive in the other organization.

According to an aspect of the invention specified by claim 7, there is provided a method of selecting a supplementary personnel which is a method of selecting a personnel supplemented to one organization from other organization, the method comprising the steps of receiving information with regard to current missions of respective organizations and missions having possibilities of being given to the organizations in the future with regard to a plurality of organizations and thereafter deducing capabilities necessary for the organizations at present and in the future by using the information, receiving information with regard to capabilities and future images of respective personnel belonging to the respective organizations and thereafter deducing capabilities held by the respective organizations at present and capabilities having possibilities of being held by the respective organizations in the future by using the information, determining excess or deficient states of the capabilities in the respective organizations by comparing necessary amounts of capabilities necessary for the respective organizations at present and in the future with capability amounts held by the organization and capability amounts having possibilities of being held by the organizations in the future for respective kinds of the capabilities with regard to the respective organizations, and sampling a personnel having a capability in the other organization or a personnel having a possibility of having the capability as a supplementary personnel to the one organization when the capability determined to be deficient at present or in the future in the arbitrary one organization is determined to be excessive at present or in the future in the other organization.

In order to execute the method of the aspect of the invention specified by claim 6, a personnel supplying system according to an aspect of the invention specified by claim 15, processes individually a plurality of organizations by information inputting means, necessary capability acquiring means, individual capability acquiring means and capability amount accumulating means and deduces a capability necessary for the organization, a capability held by the respective personnel in the organization and an accumulated value of a capability amount held by the respective personnel with regard to the capability necessary for the organization for the respective organization. Further, the system includes determining means for determining excess or deficiency states of capabilities in the respective organizations by comparing results of accumulating capability amounts provided with regard to the respective organizations with necessary amounts of the capabilities necessary for the respective organization and personnel sampling means for sampling a personnel having a capability determined to be deficient in an arbitrary organization by the determining means from other organization in which the capability is determined to be excessive.

In order to realize the method of the aspect of the invention specified by claim 7, a personnel supplementary system according to an aspect of the invention specified by claim 16, individually processes a plurality of organizations by information inputting means, necessary capability acquiring means, individual capability acquiring means and capability amount accumulating means and deduces capabilities necessary for the organization at present and in the future and capabilities held by the respective personnel in the organizations at present and capabilities having possibilities of being held thereby in the future, capability amounts held by the respective personnel at present and capability amounts having possibilities of being held thereby in the future and accumulated values of the capability amounts. Further, the system includes determining means for determining excess or deficient states of capabilities in the respective organizations by comparing results of accumulating capability amounts at present and in the future provided for the respective organizations with necessary amounts of capabilities necessary for the respective organizations at present and in the future and personnel sampling means for sampling a personnel having a capability determined to be deficient at present or in the future in an arbitrary organization by the determining means from other organization in which the capability is determined to be excessive at present or in the future.

The personnel supplementing system according the aspect of the invention specified by claim 15 or 16, is used in establishing a personnel reshuffling policy by a personnel department of a company and can also be used with an object of introducing a personnel of other organization to one organization by an outside personnel introducing company.

According to an aspect of the invention specified by claim 17, there is provided the system of supplementing a personnel according to claim 15 or 16, further comprising information outputting means for forming report information for introducing the personnel sampled by the personnel sampling means to an organization deficient of the capability and outputting the report information to outside. Similar to the aspect of the invention specified by claim 11 or 13, the information outputting means includes various modes such as a printer, a drive apparatus for a predetermined record medium and a network.

According to an aspect of the invention specified by claim 8, there is provided a method of evaluating a personnel which is a method of forming assessment information of evaluating a personnel in an organization, the method comprising the steps of receiving information with regard to a mission of the organization and deducing a capability necessary for the organization for the mission, receiving information with regard to a capability of a respective personnel belonging to the organization and deducing a capability held by the organization by using the information, determining an excess or deficient state of the capability in the organization by comparing a necessary amount of the capability with a capability amount held by the organization for respective kind of the capability necessary for the organization, and receiving information representing a business achievement of the respective personnel and thereafter forming the assessment information of the respective personnel based on the information and the excess or deficient state of the capability in the organization.

According to an aspect of the invention specified by claim 18, in order to execute the above-described method, there is provided a business achievement assessing system which is a system of assessing a business achievement of a personnel in an organization, the system comprising information inputting means for receiving information with regard to a mission of the organization, information with regard to a capability of a respective personnel belonging to the organization and information with regard to a business achievement of the respective personnel, necessary capability acquiring means for deducing a capability necessary for the organization for the mission by using input information with regard to the mission of the organization, individual capability acquiring means for deducing a capability held by the respective personnel at present by using input information with regard to the respective personnel, capability amount accumulating means for accumulating a capability amount held by the respective personnel with regard to the capability necessary for the organization for respective kind of the capability, sampling means for sampling an excess or deficient state of the capability in the organization by comparing a result of accumulating the capability amount provided by the capability amount accumulating means with a necessary amount of the capability necessary for the organization, and assessment information forming means for forming assessment information for evaluating the personnel from acquired information with regard to the business achievement of the respective personnel based on the excess or deficient state of the capability in the organization.

“Information with regard to mission of organization” in the aspect of the invention specified by claim 8 or 18, includes information with regard to the mission of the organization at present as well as information with regard to a mission which has already finished as necessary (information with regard to the past mission can also be represented by a combination of kinds of business and targets of business achievement similar to information at present or in the future).

“Information with regard to business achievement” of the respective personnel is information representing a result of evaluating a state of executing business in charge of the respective personnel by the personnel per se or a superior, showing whether the respective personnel can achieve the target set with regard to the business in charge or the degree of achievement. Also with respect to the information, by an answer pattern to a predetermined number of assessment items, predetermined patternized information can be derived. Further, inputted information may be either of the information before patternization and information after patternization.

Further, a business achievement assessing system according to an aspect of the invention specified by claim 19, includes information outputting means for forming report information indicating assessment information of the respective personnel and outputting thereof to outside. Further, although in outputting the report information, the assessment information of the respective personnel may be summarized and outputted to the organization, assessment information inherent to the respective personnel can also be outputted.

Similar to the information outputting means in the aspects of the invention specified by claims 11, 13 and 17, the information outputting means includes various modes.

An aspect of the invention specified by claim 20 relates to an information transmitting medium written with information constituting an object by at least either of an organization and respective personnel in the organization by a computer system. The computer system samples an excess or deficient state of the capability of the organization with regard to a capability necessary for a mission of the organization and thereafter sets a direction of growing the respective personnel from information with regard to the capability of the respective personnel based on a result of sampling thereof and the medium is written with the personnel fostering plan formed by using the direction of growing the respective personnel.

An aspect of the invention specified by claim 21 relates to an information transmitting medium written with information constituting an object by an organization by a computer system. The computer system samples an excess or deficient state of a capability of the organization with regard to a capability necessary for a mission of the organization and thereafter sets a direction of growing a respective personnel from information of a capability of the respective personnel based on a result of sampling thereof and samples a supplementary personnel in accordance with a capability deficient in the organization from a data base and the medium is written with a plan of fostering a personnel formed by using the direction of growing thereof and information for introducing the supplementary personnel.

An aspect of the invention specified by claim 22 relates to an information transmitting medium written with information constituting an object by a respective personnel of an organization by a computer system.

The computer system determines an excess or deficient state of a capability of the organization with regard to a capability necessary for a mission of the organization and writes information for assessing business achievement formed by business achievement of the respective personnel based on a result of determining thereof to the medium.

The respective information transmitting media of the aspects of the invention specified by claims 20 through 22, include record media capable of being written with various information after having been electronized (floppy disk, compact disk) other than a paper medium.

According to the aspects of the invention specified by claim 1 and claim 9, there is derived the excess or deficient state of the capability amount in the organization from the necessary amount of the capability necessary for executing the mission by the organization and the capability amount held by the organization provided from the respective personnel in the organization. The direction of growing the respective personnel is set by the excess or deficient state of the capability of the organization and the capability of the respective personnel and therefore, the personnel fostering plan in accordance with the mission of the organization can be formed by setting the direction of growing the personnel in the direction of promoting the capability particularly deficient for the organization in capabilities provided to the respective personnel.

Further, when used information is limited to information with regard to a mission in a short term, the personnel fostering plan stays to set to an effort target of the respective personnel in the time period of the mission. In contrast thereto, when there is carried out a processing of adding a mission of the organization in the future and a capability of the respective personnel anticipated in the future, there can be formed a personnel fostering plan for leading the respective personnel in a direction of providing a capability which can be necessary for the organization in the future.

According to the aspects of the invention specified by claim 2 and claim 10, there are derived the capability deficient in executing the mission of the organization at present, the capability deficient for the organization in the future and the capability which must be supplemented in executing the mission in the future by the present organization from the necessary amount of the capability necessary for the organization in executing the mission at present and in the future and the capability amount held by the organization provided by the respective personnel in the organization and the capability amount having the possibility of being held thereby in the future. Therefore, when there is deficient the capability amount of the organization at present with regard to business necessary for the mission of the organization in the future, there can be set the direction of growing the personnel giving importance to the capability necessary for the organization, particularly deficient capability in capabilities having possibilities of promoting by the respective personnel in the future, to a personnel having a high possibility of promoting the capability or a personnel having high interest in the business such as expediting self-help effort for promoting the capability.

Further, according to the aspect of the invention specified by claim 11, the fostering policy is outputted as a report and is presented to at least either one of the organization and the individual personnel.

According to the aspect of the invention specified by claim 3 or 12, there is sampled deficient capability in executing a mission by the organization by deducing a capability necessary for the organization and a capability held by the organization from information with regard to the mission and information with regard to the capability of the personnel in the organization and comparing thereof with respect to the organization. Further, based on a result of sampling thereof, there is selected a personnel supplementing the capability deficient for the organization or a business service.

Further, when used information is limited to a mission of a short term or a capability of a personnel at present, there is selected a personnel as instant capability or a service. In contrast thereto, when there is used also information in the future, there can be selected a personnel or a service in accordance with a future conception of the organization.

According to the aspect of the invention specified by claim 4 or 13, after sampling capability amounts deficient for the organization at present and in the future, the direction of growing the personnel is set to promote the deficient capability and there is formed a plan to the organization indicating the direction of growing the personnel. Further, there is selected a personnel supplementing a capability deficient in executing the mission by the organization at present or a business service or a personnel supplementing a capability deficient during the time period until the respective personnel in the organization grows in line with the set direction of growing thereof or a business service to the organization.

According to the aspect of the invention specified by claim 5 or 14, there is determined a reward sum charged to the organization in accordance with a degree of promoting a capability of a personnel in the organization after a predetermined time period since the personnel fostering plan has been presented. Therefore, when content of the plan to the organization is pertinent, the degree of promoting the capability of the respective personnel is also increased and a high reward sum is set.

According to the aspect of the invention specified by claim 6 or 15, a personnel who is not suitable for a mission of the organization can be set as a supplementary personnel of other organization needing a capability of the personnel.

According to the aspect of the invention specified by claim 7 or 16, even a personnel who is not suitable for the mission of the organization at present or the future conception, can be set as a supplementary personnel of other organization in accordance with a capability and a future image of the personnel.

Further, according to the aspect of the invention specified by claim 17, a report introducing the personnel is outputted to the organization constituting the supplementary destination of the supplementary personnel.

According to the aspect of the invention specified by claim 8 or 18, there is formed assessment information using business achievement of individual personnel and the excess or deficient degree of the capability of the organization and therefore, there can be carried out an assessment reflecting a contribution degree of the respective personnel with regard to growth of the organization such as attaching a high evaluation mark when, for example, achievement in business using the capability is promoted regardless of the fact that capability of the organization is significantly low.

Further, according to the aspect of the invention specified by claim 19, by assessment information formed with regard to the respective personnel, there is outputted information constituting a report to the organization or notice or an assessment result to the respective personnel.

There is provided plan information transmitting medium outputting a personnel fostering plan according to an aspect of the invention specified by claim 20, a personnel fostering plan and information for introducing a supplementary personnel according to an aspect of the invention specified by claim 21 or the information for assessing business achievement according to an aspect of the invention specified by claim 22 by a predetermined format respectively by a computer.

### BRIEF DESCRIPTION OF THE DRAWINGS

FIG. 1 is a diagram for explaining concept of a mission in an organization and conditions necessary for executing the mission;

FIG. 2 is a diagram for explaining a specific example of kinds of capabilities;

FIGS. 3A and 3B are diagrams for explaining concept of an amount of necessary personnel;

FIG. 4 is a diagram for explaining an outline of a processing for calculating an amount of necessary personnel;

FIG. 5 is a diagram for explaining fields of applying the invention;

FIG. 6 is a diagram for explaining a conventional example of a personnel fostering plan forming system;

FIG. 7 is a diagram for explaining an outline of a personnel fostering plan forming system to which the invention is applied;

FIG. 8 is a diagram for explaining an outline of a processing by a personnel fostering plan forming system;

FIG. 9 is a diagram for explaining a conventional example of a personnel dispatching system;

FIG. 10 is a diagram for explaining a personnel dispatching system to which the invention is applied;

FIG. 11 is a diagram for explaining a role achieved by a dispatch personnel to an organization;

FIG. 12 is a diagram for explaining a role of service of a personnel dispatching system with regard to an organization;

FIG. 13 is a diagram for explaining a relationship between a personnel dispatching company and an organization;

FIG. 14 is a diagram for explaining an outline of a processing executed by a personnel dispatching system;

FIG. 15 is a diagram for explaining a processing of calculating yield in a personnel dispatching system;

FIG. 16 is a diagram for explaining concept of yield according to the invention;

FIG. 17 is a diagram for explaining a conventional example of a personnel introducing system;

FIG. 18 is a diagram for explaining a personnel introducing system to which the invention is applied;

FIG. 19 is a diagram for explaining an outline of a personnel introducing system;

FIG. 20 is a diagram for explaining an outline of a processing in a personnel introducing system;

FIG. 21 is a diagram for explaining a conventional example of a business achievement assessing system;

FIG. 22 is a diagram for explaining a business achievement assessing system to which the invention is applied;

FIG. 23 is a diagram for explaining an outline of a processing in a business achievement assessing system;

FIG. 24 is a diagram for explaining a relationship between a control department and an organization using a personnel fostering plan forming system;

FIG. 25 is a block diagram showing a hardware constitution for realizing a personnel fostering plan forming system;

FIG. 26 is a view for explaining a relationship of data input/output executed between a system and an organization;

FIG. 27 is a block diagram showing a function of processing means of a personnel fostering plan forming system and a data constitution of a data base unit;

FIG. 28 is a flowchart showing a procedure of acquiring an amount of necessary personnel;

FIG. 29 is a flowchart showing a procedure of acquiring assessment information of capabilities;

FIG. 30 is a flowchart showing a procedure of acquiring an amount of accumulated capabilities;

FIG. 31 is a flowchart showing a procedure of comparing amounts of capabilities;

FIG. 32 is a flowchart showing a procedure of forming strong and weak points data;

FIG. 33 is a flowchart showing a procedure of forming an individual plan;

FIG. 34 is an explanatory view showing an output example of an individual plan;

FIG. 35 is a flowchart showing a procedure for forming a personnel fostering plan;

FIG. 36 is an explanatory view showing an output example of a personnel fostering plan;

FIG. 37 is a diagram for explaining a relationship between a personnel dispatching company and an organization using personnel dispatching service;

FIG. 38 is a diagram for explaining a processing of setting yield charged to an organization by a personnel dispatching company;

FIG. 39 is a block diagram showing a function of processing means of personnel dispatching service and a data constitution of a data base unit;

FIG. 40 is a flowchart showing a procedure of sampling dispatch personnel;

FIG. 41 is a flowchart showing a procedure of setting yield;

FIG. 42 is a diagram for explaining a relationship between a personnel introducing company and an organization introducing a personnel introducing system;

FIG. 43 is a block diagram showing a function of processing means of a personnel introducing system and a data constitution of a data base unit;

FIG. 44 is a flowchart showing a processing of sampling an introduced personnel;

FIG. 45 is a flowchart showing a procedure of forming personnel introducing plan;

FIG. 46 is a diagram for explaining a relationship between a control department and an organization using a business achievement assessing system;

FIG. 47 is a block diagram showing a function of processing means of a business achievement assessing system and a data constitution of a data base unit;

FIG. 48 is a flowchart showing a procedure of forming a business achievement assessment report;

FIG. 49 is a diagram for explaining output items when an individual plan is outputted by a personnel dispatching system;

FIG. 50 is a diagram for explaining a personnel fostering plan proposed to an organization by a personnel dispatching system and output items when a personnel dispatching plan is outputted;

FIG. 51 is a diagram for explaining output items when a personnel introducing plan is outputted by a personnel introducing system;

FIG. 52 is a diagram for explaining output items when a report to respective personnel is outputted by a business achievement assessing system;

FIG. 53 is an explanatory view showing a specific example of business which is dealt with by an outsourcing company;

FIG. 54 is an explanatory view showing a specific example of business constituting a service object of a specialized supporting company; and

FIG. 55 is a diagram for explaining modes of personnel dispatching companies.

### DETAILED DESCRIPTION OF THE PREFERRED EMBODIMENTS

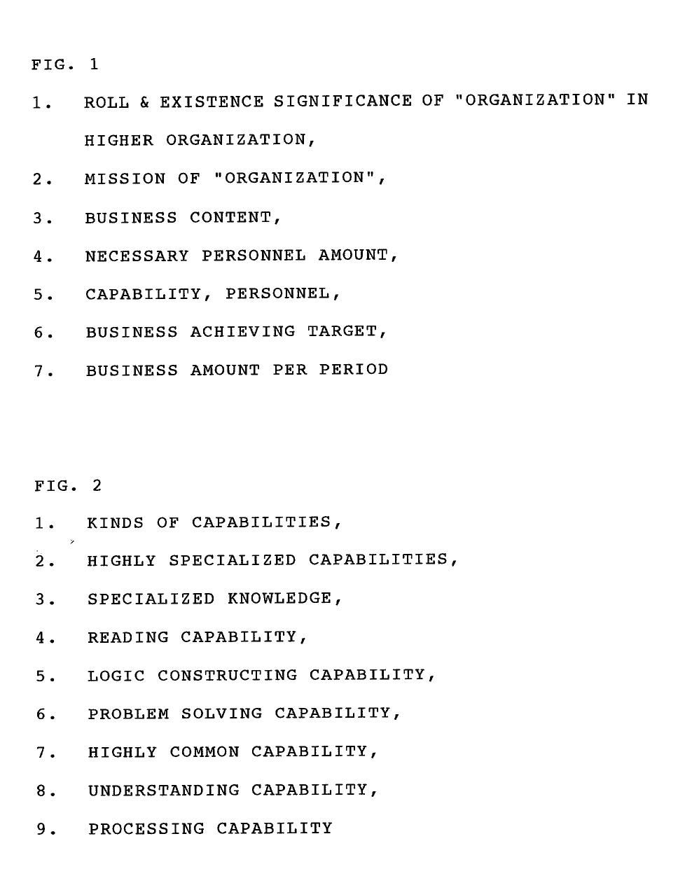

FIG. 1 shows concept of a mission of an organization and conditions necessary for executing the mission.

In view of inside of a company, “organization” mentioned here, is an organization of various unit such as division, department, section, subsection, subgroup or the like and there also is the case in which a total of a company is regarded as one organization. The mission of the organization is generally determined by what role or significance of existence is provided to the organization in an organization higher than the organization and can specifically be regarded as being accompanied with information indicating content of business to be executed and a business achieving target thereof. The business achieving target (hereinafter, simply referred to as “business target”) includes elements of a business amount, an achieving period and quality of a job and a business amount in a predetermined period of time can necessarily be derived from these elements.

A business amount in a period of time is indicated by a method which differs by content of business such as sales money or a number of contracts during the period in the case of a sales department, or up to what stage a development schedule has been finished in the case of a development apartment. However, in any of the business, in order to execute the business, there are needed a predetermined number of personnel having predetermined capabilities in accordance with the business content and therefore, the business amount in the period of time can be indicated by substituting the business amount for a number of personnel having capabilities of executing the business.

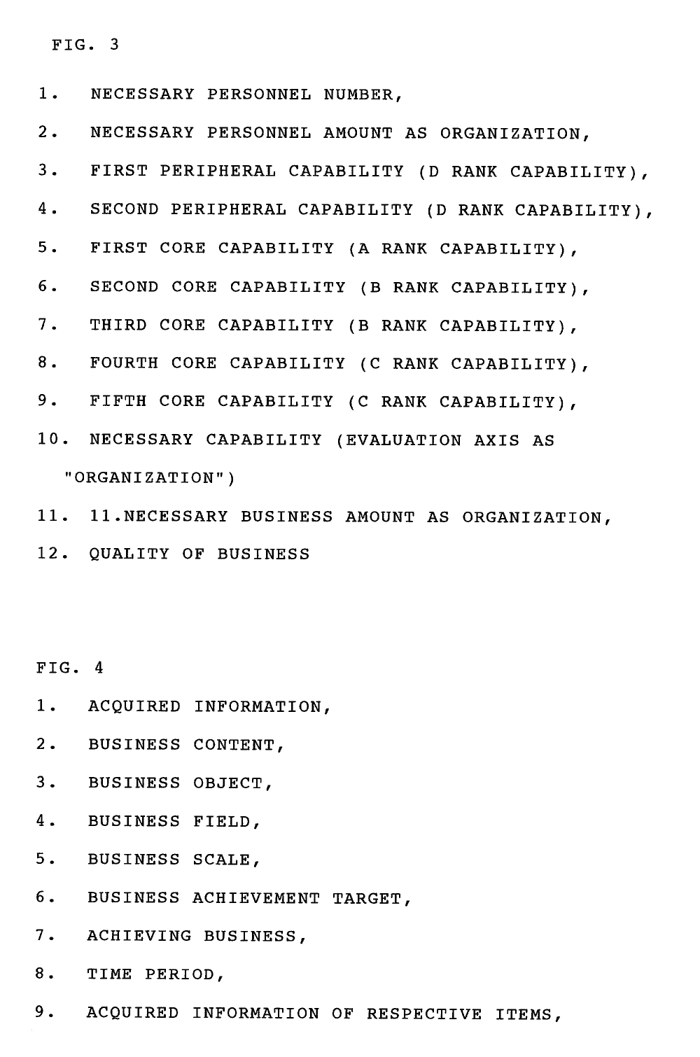

Generally, in order to execute one business, it is necessary to achieve a plurality of kinds of capabilities. The capabilities can be divided in two of highly specialized capabilities particular to the business (for example, specialized knowledge with regard to basic technical fields such as electrical engineering, mechanical engineering, optics and the like, linguistic capability, capability of constituting and expressing logic) and capabilities having high possibility of being common to any business (capability of receiving and understanding explanation, capability of clerical processing) (refer to FIG. 2).

In the following explanation, capability necessary for executing business is referred to as “necessary capability” and a personnel having the necessary capability is referred to as “necessary personnel”. The necessary capability indicates concept integral with a plurality of capabilities necessary for executing business.

For example, when a certain personnel gains respectively predetermined passing marks with regard to a plurality of kinds of capabilities in accordance with a certain business, the personnel can be acknowledged as having the necessary capability for executing the business. Further, in any of the capabilities, the higher the mark, the higher capability seems to be provided to the personnel and therefore, a degree of highness of necessary capabilities provided to the personnel can be indicated by, for example, a total of marks of respective capabilities (hereinafter, the degree of highness of capability provided to individual personnel is referred to as “capability amount”). Therefore, the “necessary capabilities” can be represented by a combination of kinds of capabilities necessary for business and capability amounts thereof.

Assuming that capability amounts of necessary personnel with regard to business are uniformly at a level reaching a passing mark, the condition for achieving the target of the business can be indicated by how many necessary personnel are needed.

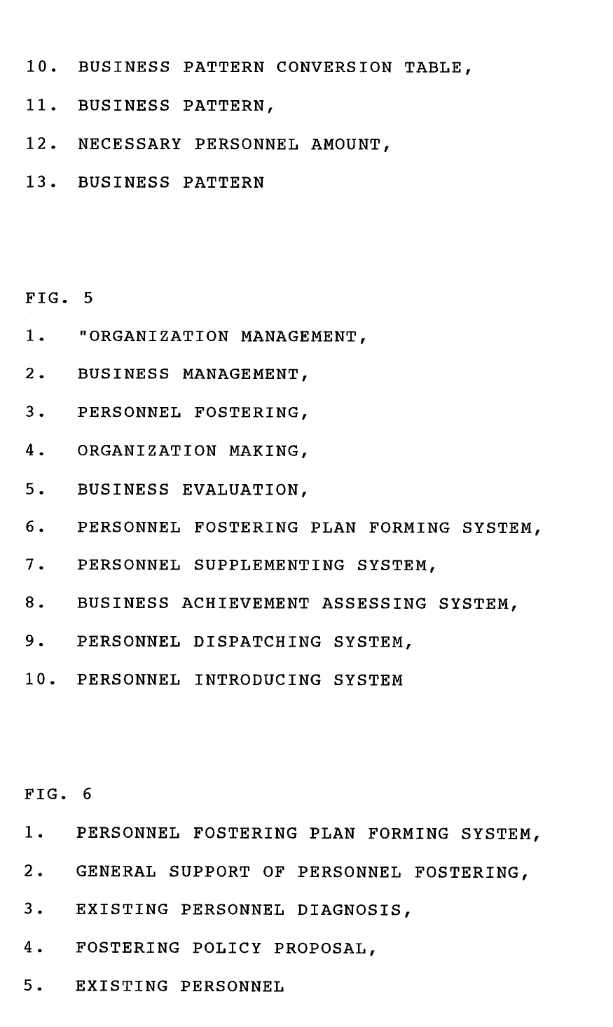

FIGS. 3A and 3B schematically show a necessary personnel amount necessary for executing a mission by an organization.

Business for executing a mission of an organization is classified in two of core business accompanied by a processing directly related to content of the mission (for example, business of proposing a new commodity, business of designing a product or a system) and support business for smoothly executing the core business (document arrangement, copy of document or drawing, miscellaneous affairs business). Either of the core business and the support business includes a plurality of kinds of business and the business is evaluated by a degree of contribution to the mission of the business and an easiness degree thereof.

In the illustrated example, a capability of executing core business is indicated as “core capability” and a capability of executing support business is indicated as “peripheral capability”. Either of the core capability and the peripheral capability is evaluated in correspondence with business executed by the capability. A condition for achieving targets of respective business is represented by a combination of necessary capabilities of the business and a number of necessary personnel (in the drawing, indicated as “necessary personnel number”) and an aggregation of a pattern of the combinations represents a condition for executing a mission as a total of the organization.

Here, information by an aggregation of combinations of various necessary capabilities and necessary personnel numbers in the organization (corresponding to a portion of rectangular frame in FIG. 3A) is defined as “necessary personnel amount”. Further, when it is regarded that business is constituted by a result of achieving necessary capabilities by respective necessary personnel, by way of regarding that total amounts of a necessary personnel amount and a business amount of an organization are the same, as shown by FIG. 3B, the necessary personnel amount can be converted into an aggregation of combinations of respective business executed in the organization and a necessary personnel number thereof (here, referred to as “necessary business amount”).

Further, normally, even in the case of a personnel who is acknowledged to have the same necessary capability, a capability amount thereof differs and the more the personnel having high capabilities are included, the smaller the number of necessary personnel can be made. Therefore, it is also possible to indicate a condition of executing a mission of an organization by an aggregation of combinations of respective necessary capabilities and capability amounts thereof by, for example, evaluating a core capability of A rank as ∘ point, a core capability of B rank as X point . . . (hereinafter, information by an aggregation of capability amounts is referred to as “necessary capability amount”)

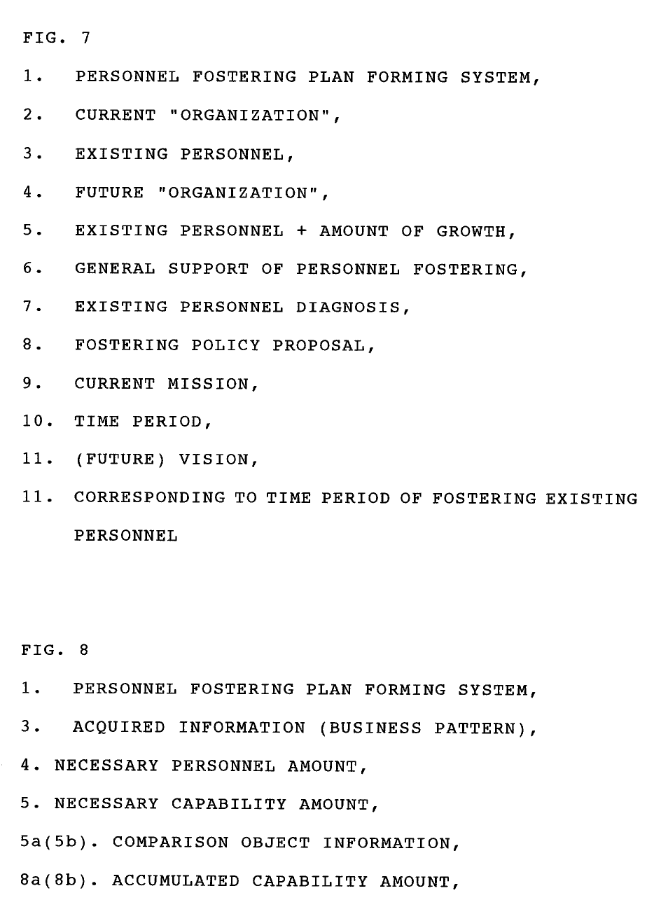

FIG. 4 shows an outline of a processing for calculating a necessary personnel amount in the computer system.

Information indicating the business content or business achievement target includes information with regard to a plurality of items as illustrated. In order to acquire information of the respective items from an organization, for example, a questionnaire setting questions for the respective items is given to the organization and answer to the respective question is inputted to a computer system.

The computer system is previously set with a conversion table for deducing content of business and a business amount per a predetermined period of time from an answer pattern for the respective question (mission/vision determining table, mentioned later) and a table (indicated as “business pattern conversion table” in the drawing) setting a number of necessary personnel adapted to a condition indicated by respective pattern for respective pattern of a combination of content of business and a business amount per period of time (hereinafter, the combination pattern is referred to as “business pattern”) for various business. A control unit of the computer system specifies a business pattern executed in the organization by applying the inputted answer to the respective question to the conversion table and thereafter calculates a necessary personnel amount in the organization by applying the business pattern to the business pattern conversion table.

FIG. 5 shows fields to which the invention is applied.

First, the invention can be used for determining a policy of fostering respective personnel belonging to an organization (hereinafter, referred to as “existing personnel”) (hereinafter, a system for determining the personnel fostering policy is referred to as “personnel fostering plan forming system”).

The system can not only be used in a department such as a personnel and education department of an enterprise but can also be used by a specific personnel in an organization such as a controller or a personnel in charge of education in an organization. Further, there also is a case in which the system is used for proposing a plan of fostering respective personnel to an organization by an outside organization for supporting management of the organization.

Next, the invention can be applied for selecting supplementary personnel in supplementing new personnel to an organization (hereinafter, a system for selecting the supplementary personnel is generally referred to as “personnel supplementing system”).

The personnel supplementing system is used in a personnel department of a company with an object of employing newly employed personnel or temporary personnel (part-timers, student workers) and determining positions assigned therefor or making a policy of personnel reshuffling. Further, as in specific examples shown below, the personnel supplementing system can also be applied to a system of selecting dispatch personnel in a personnel dispatching company (hereinafter, referred to as “personnel dispatching system”) or a system used in a service of making a personnel belonging to a predetermined organization belong to other organization by a personnel introducing company (hereinafter, referred to as “personnel introducing system”).

Further, the invention is applicable to a system of assessing business achievement of respective personnel in an organization (hereinafter, the system is referred to as “business achievement assessing system”).

Further, the invention can be used not only in the above-described four kinds of systems but also for an organization utilizing the outside business service or a provider of the business service with an object of making a service utilizing plan optimum for an organization.

An explanation will be given of characteristics of systems caused when the invention is applied to the above-described four kinds of system in comparison with a conventional system.

\mathring{1} Personnel Fostering Plan Forming System

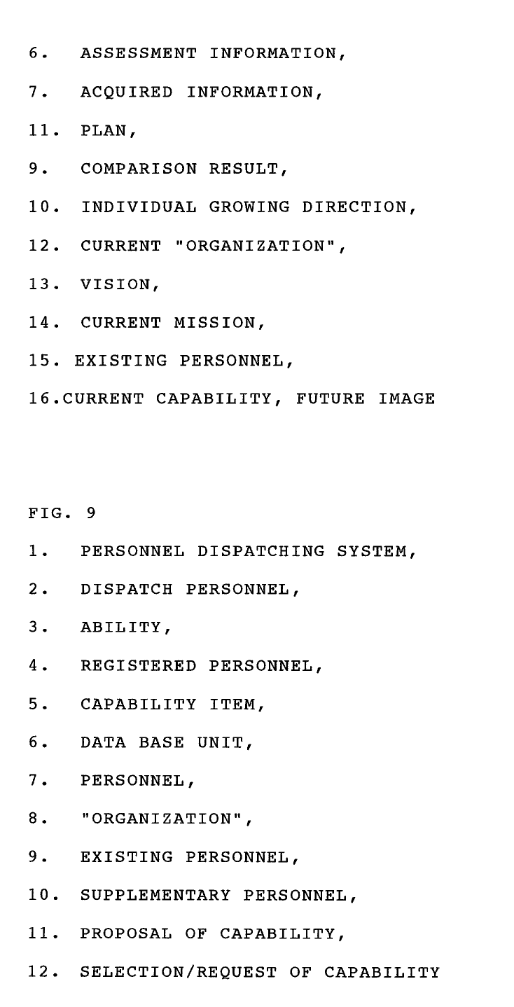

FIG. 6 shows a conventional example of a personnel fostering plan forming system.

The system samples strong points and weak points of personnel by using information indicating capabilities of personnel provided by executing predetermined capability test for existing personnel (existing personnel diagnoses). Further, from the sampling result, as effort targets inherent to personnel, data indicating kinds of capabilities constituting strong points and target values of amounts of promoting the capabilities, is set and is outputted in a predetermined style (fostering policy proposal).

According to the above-described system, there is shown only the fostering plan based on strong points and weak points of individual personnel and therefore, when capabilities shown to personnel as effort targets are capabilities sufficiently held by an organization, the above-described fostering policy does not contribute to executing mission of the organization at all. On the contrary, when the capabilities shown to the personnel coincide with capabilities deficient for the organization, achievement of the effort targets by the personnel significantly contributes to executing mission by the organization. In the personnel fostering plan forming system according to the invention, by showing the effort targets in the latter case to the respective personnel, both of organization and personnel are grown.

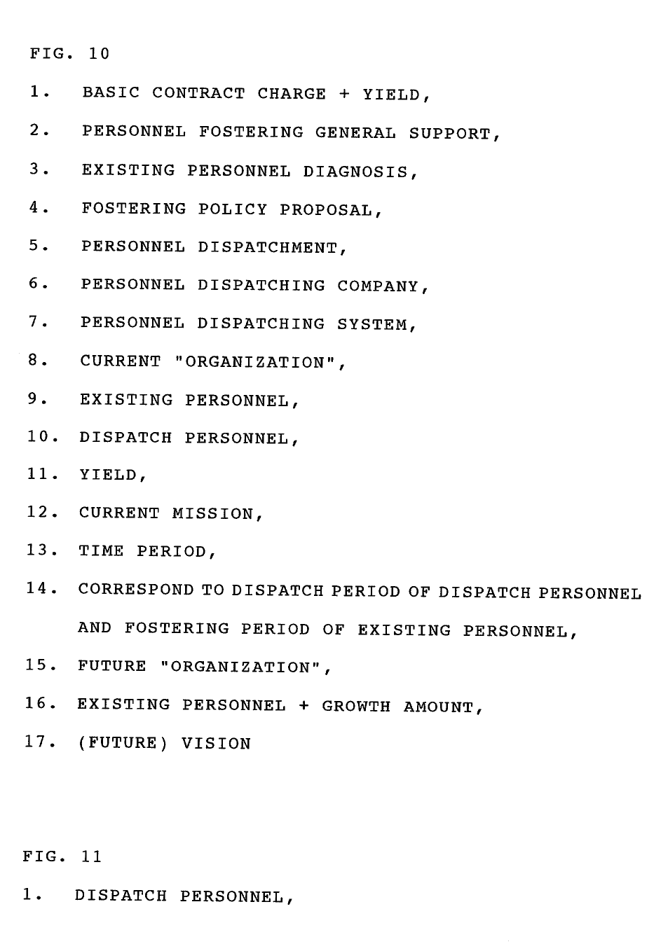

FIG. 7 shows an outline of a personnel fostering plan forming system to which the invention is applied.

The system obtains information with regard to current mission and future vision (indicating role and significance of existence borne by an organization in the future, that is, content of mission having a possibility given to the organization in the future) from the organization and obtaining information with regard to current capabilities and future images of respective personnel currently belonging to the organization (hereinafter, referred to as “existing personnel”) and determining capabilities currently held by the organization and capabilities having possibilities held thereby in the future. Further, by comparing a capability amount of the organization with a capability amount necessary for executing mission or obtaining vision by the respective organization, there is set a fostering policy capable of determining capabilities deficient for the organization and a deficient amount thereof, equipping the respective existing personnel with the deficient capabilities and growing the organization toward the future vision in a predetermined period of time and the fostering policy is proposed to the organization and the respective existing personnel.

FIG. 8 shows an outline of a processing executed by the personnel fostering plan forming system.

The personnel fostering plan forming system sets an individual direction of growing respective existing personnel (hereinafter, referred to as “individual growing direction”) by using information with regard to mission and vision of an organization and information with regard to current capability and future image of existing personnel. Further, the system forms a personnel fostering plan (proposal showing a policy of fostering respective personnel) to an organization and an individual plan (proposal individually showing a direction of growing respective personnel) to respective personnel by using individual directions of growing respective personnel.

The information with regard to mission and vision is derived from information provided by a questionnaire and hearing to a controller of the organization and is given to the system in a style of answer to questions with regard to a plurality of kinds of items as shown by FIG. 4.

The information with regard to a capability of existing personnel is obtained by presenting, for example, various kinds of capability items to respective personnel or a controller of the organization. The capability items are set by a single or a plurality of items for respective kind of capability and constructed by a data constitution corresponding questions for measuring capability amounts and criteria to “headings” indicating kinds or contents of capabilities. Therefore, assessment of capabilities of existing personnel is carried out by presenting questions for the respective capability items, attaching evaluation marks to the answer and acknowledging capabilities with regard to items in which the evaluation marks reach predetermined passing marks as capabilities of personnel. Information finally processed by the system is set as information combining kinds (contents) of capabilities provided to personnel and information numerizing capability amounts thereof. (In the following explanation, the information is referred to as “assessment information of capability amount)

The future image is information with regard to future intentions and interests of existing personnel, capabilities of personnel expected by the organization and capabilities having possibilities of being promoted in the future and similar to assessment information, based on a result of answer of personnel or a controller to a plurality of kinds of questions, there is set information showing kinds of capabilities and capability amounts having possibilities held by respective personnel in the future.

According to the personnel fostering plan forming system, based on the principle of FIG. 4, there is deduced the business pattern from acquired information with regard to current mission and vision of the organization and thereafter, a current and future business pattern 3 is applied respectively to the business pattern accumulating data base to thereby calculate a current and future necessary personnel amount 4. Further, the necessary personnel amount 4 is replaced by a necessary capability amount 5.

Further, the necessary capability amount 5 can also be derived directly from the business pattern 3 and the necessary capability amount 5 can also be shown by being replaced by the necessary personnel amount 4 as necessary.

Further, with regard to assessment information 6 at current time (designated as “current capabilities” in the drawing) and information 7 indicating future images of capabilities of existing personnel, there is acquired information indicating respective capabilities currently held by respective personnel and capabilities having possibilities of being held by the respective personnel in the future (specifically, kinds of capabilities and capability amounts thereof).

The system obtains a capability amount 8 currently held by the organization by accumulating capability amounts of respective existing personnel for respective kinds of capabilities by using the assessment information 6 of the respective existing personnel (hereinafter, referred to as “accumulated capability amount 8a”). Further, the system acquires capability amounts of respective existing personnel anticipated in the future by using the acquired information 7 with regard to future images of the respective existing personnel, thereafter accumulates the capability amounts anticipated with regard to the respective existing personnel for respective kinds of capabilities and obtains the capability amount 8 having a possibility of being held by the organization in the future (hereinafter, referred to as “anticipated accumulated probability amount 8b”).

Further, the system compares the accumulated capability amount 8a and the anticipated accumulated capability amount 8b respectively with current and future necessary capability amounts 5a and 5b. Further, based on comparison results 9, there are formed directions 10 of individually growing the respective existing personnel and a plan 11.

Directions of individually growing the respective existing personnel are set based on excess or deficiency states of capabilities for executing mission and vision by the organization and capabilities and future images of individual existing personnel. For example, when there is a personnel who can be expected to grow highly in a capability amount with regard to a capability deficient for the organization, information indicating a kind of the capability and a degree of promoting the capability amount constituting a target, is set as a growing direction. Further, the personnel fostering plan or the individual plan is formed by applying individual growing directions of respective personnel and various information used in deriving the individual growing directions to predetermined templates, although details thereof will be given later.

Further, according to the system of FIGS. 7 and 8, information with regard to future vision of the organization and future images of respective existing personnel are not information which must be obtained necessarily but a personnel fostering plan effective in executing mission by an organization can be formed only by information indicating the current state. However, when the processing is carried out by also using future information, there can be formed more excellent plan in consideration of a picture aimed by the organization.

\mathring{2} Personnel Dispatching System

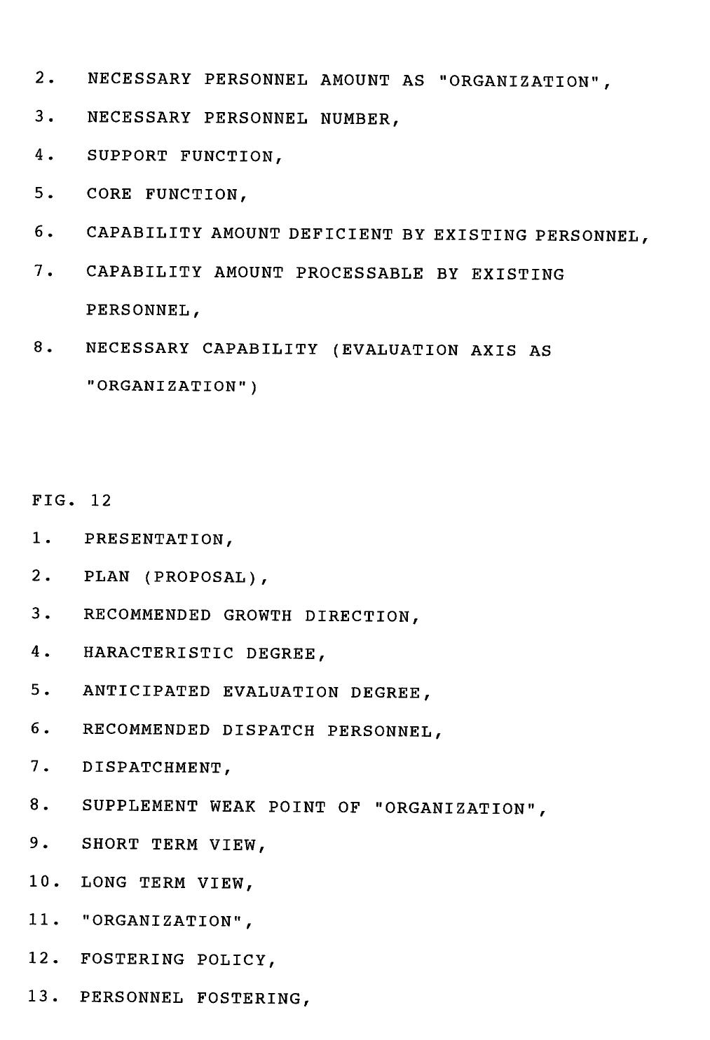

FIG. 9 shows a conventional example of a personnel dispatching system.

The personnel dispatching system is provided with a data base unit 85 registered with various capability items for assessing capabilities of dispatch personnel and profiles of a plurality of personnel constituting a dispatch object. The capability items are constructed by a data constitution similar to that used in assessing capabilities of existing personnel in the personnel fostering plan forming system. The system presents the respective capability items to outside personnel who intend to register, determines kinds of capabilities and capability amounts held by the personnel from answer of the personnel to respective questions and registers thereof to the data base unit 85.

An organization constituting a client presents a desired condition with regard to a capability of dispatch personnel and a dispatch time period to a personnel dispatching company. The personnel dispatching system samples a personnel who meets the request of the side of the organization from the data base unit 85 and presents the registered capability to the side of the organization. Further, when a plurality of dispatch personnel are presented, the organization selects a desired personnel from the presented personnel and receives dispatchment of the personnel.

According to the above-described system, only a personnel in accordance with a condition presented from the side of the organization is selected and no consideration is given to whether the personnel is a personnel truly necessary for achieving mission of the organization or whether the personnel can contribute to future growth of the organization.

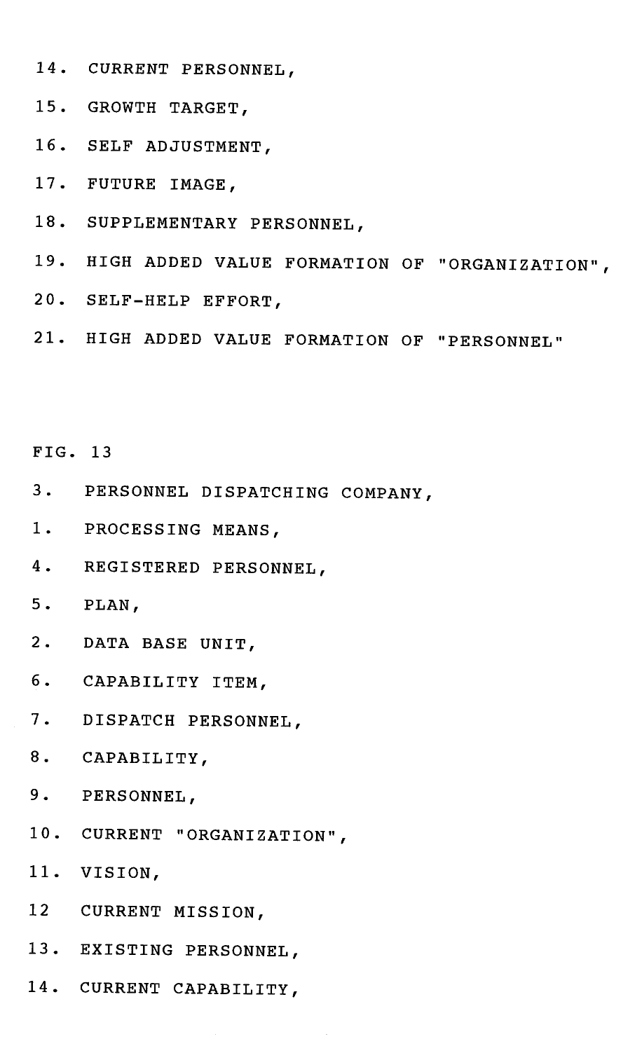

FIG. 10 shows an outline of a service by a personnel dispatching system to which the invention is applied.

A personnel dispatching company controlling the personnel dispatching system diagnoses capabilities and aptitudes of existing personnel of an organization constituting a client and dispatches personnel supplementing capabilities deficient in executing current mission by the organization. Further, the personnel dispatching company sets a policy of fostering the existing personnel and proposes thereof to the organization such that the organization can grow toward future vision and dispatches personnel suitable for the respective current personnel to carry out self-help effort in line with the fostering policy.

Proposal of the personnel fostering policy is carried out by diagnosing capabilities, aptitudes and intentions of the respective existing personnel and thereafter presenting a personnel fostering plan to the organization. Further, the personnel dispatching company makes a scheme of personnel dispatched to the organization and presents a plan of dispatching personnel indicating the content of the scheme to the organization along with the personnel fostering plan.

As shown by FIG. 11, personnel dispatched to the organization are positioned as personnel for supplementing a capability amount which becomes deficient by existing personnel with regard to a personnel amount necessary for the organization. According to the personnel dispatching plan of FIG. 10, as dispatch personnel immediately after starting the service, there are selected personnel for supplementing deficient capabilities to a necessary personnel amount based on the current mission and selects dispatch personnel after elapse of a predetermined time period from start of the service based on a necessary personnel amount sampled in accordance with the future vision or an intermediate target for progressing to the vision and proposes dispatch personnel at the respective time points to the organization.

Further, a timing of changing dispatch personnel is not particularly prescribed but content of dispatch personnel may be changed at a plurality of steps during a time period of fostering the existing personnel of the organization. Further, when the necessary personnel amount is deficient even with capabilities of the existing personnel at a time point of finishing the fostering period, there are proposed dispatch personnel for supplementing the deficient capability amount.

Referring back to FIG. 10, at a time point at which the proposed period of fostering personnel has elapsed, the personnel dispatching company sets “yield” in accordance with promotion of capabilities of the respective existing personnel and charges thereof to the organization. Further, with regard to the dispatch personnel, other than basic contract charge of a predetermined amount, there is paid “yield” in accordance with promotion of capabilities of the existing personnel in the dispatched time period. However, it is not necessarily needed to set the “yield”.

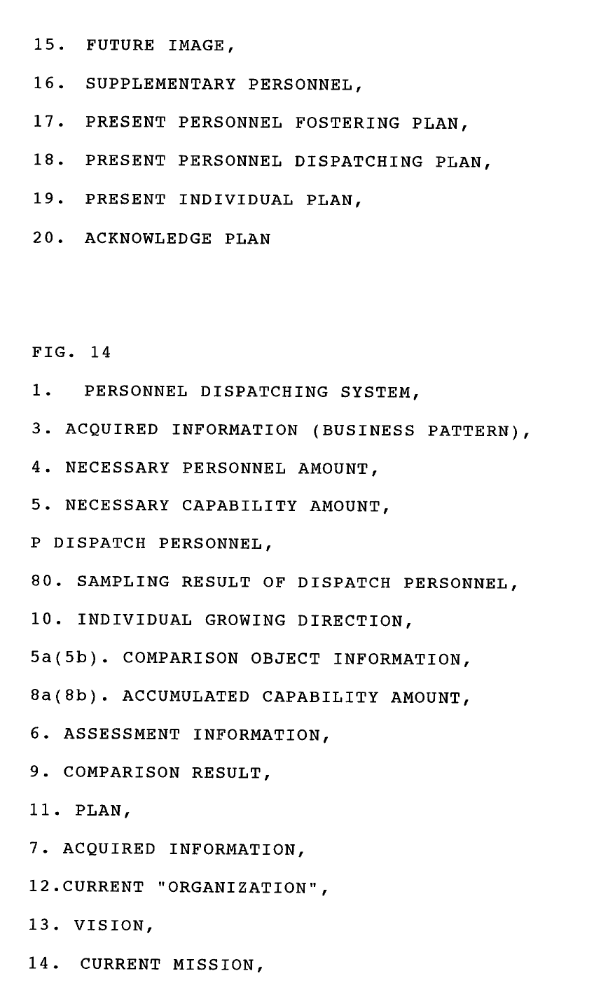

FIG. 12 shows a role of service of the personnel dispatching company to the organization by the above-described system.

A growing direction presented to respective existing personnel is formed as information including a characteristic degree based on current capabilities of the existing personnel (refer to kinds of capabilities constituting strong points and weak points in carrying out business of the organization and a degree of excess or deficiency of capability amounts thereof) and an anticipated evaluation degree (refer to kinds of capabilities anticipated to promote in the future and a degree of promoting capability amounts thereof).

The organization sets a policy of fostering the respective existing personnel in accordance with the personnel fostering plan and the personnel dispatching plan proposed by the personnel dispatching company and fosters the respective personnel in line with the policy. Further, the respective existing personnel carries out self-help effort in order to promote capabilities toward the proposed growing direction while correcting future images in accordance with the growing direction individually presented. By promoting the capabilities in the proposed direction by the respective members, a capability amount of a total of the organization becomes proximate to a necessary capability amount for dealing with a business pattern shown in the vision.

The personnel dispatching company not only dispatches personnel for supplementing a deficiency in capability in the initial state of the organization at a time point of starting the service but also pertinently switches the dispatch personnel to the dispatch personnel sampled in the long term view of supplementing a deficiency in capability in a procedure of growing the respective existing personnel. Further, when there still are capabilities deficient in achieving the future vision even at a time point at which the respective existing personnel have grown in accordance with the growing directions, there are dispatched personnel for supplementing the deficiency in capability.

Therefore, the organization can grow the existing personnel in accordance with a target as a total of the organization while receiving dispatchment of personnel necessary for growing the organization and can grow in a direction of realizing the future vision as the total of the organization.

Further, even in the personnel dispatching system, it is not that the information with regard to the future vision of the organization and future images of the existing personnel must necessarily be deduced but the system may only carry out the current mission and a processing using assessment information of current capabilities of the respective existing personnel. In this case, the system samples capabilities deficient in carrying out the current business by the organization by comparing the necessary capability amount in the current organization with a current accumulated capability amount provided by the existing personnel of the organization and samples dispatch personnel for supplementing the deficiency in capability and therefore, the system can convert from the conventional personnel dispatching service of only meeting request of the organization to the personnel dispatching service capable of pertinently corresponding with the excess and deficiency state of the capability of the organization. Further, it is possible to show effort targets in accordance with capabilities and aptitudes of personnel in executing the mission to the existing personnel. However, in this case, it is not necessarily needed to present the effort targets.

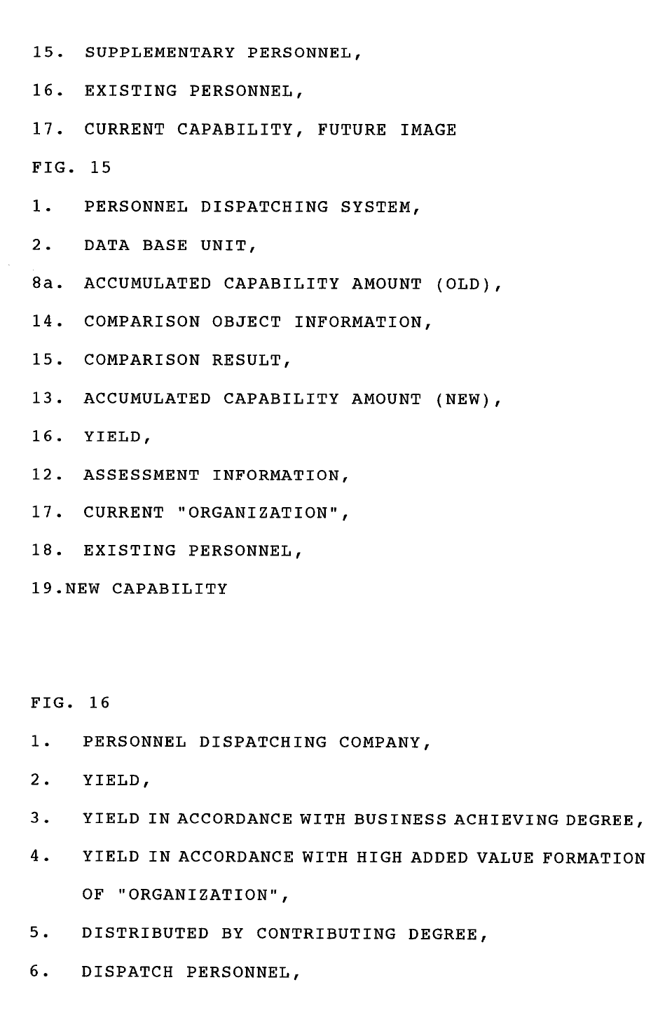

FIG. 13 shows a relationship between the personnel dispatching company using the personnel dispatching system and the organization.

The personnel dispatching system includes processing means 1 for making various plans by receiving information from the organization and the existing personnel and a data base unit 2. The processing means 1 is realized by giving programs to CPU of a computer for obtaining information with regard to current mission and vision of the organization, assessment information with regard to current capabilities of the respective current personnel and information with regard to future images of the current personnel, making the personnel fostering plan and the personnel dispatching plan and selecting dispatch personnel.

The processing means 1 sets individual growing directions of the respective existing personnel by a method similar to that of the personnel fostering plan forming system by using obtained various information. Further, the growing direction can be adjusted at respective time of assessing capabilities for checking promotion of capabilities of the respective existing personnel.

Further, the processing means 1 makes the personnel fostering plan and the personnel dispatching plan to the organization by using the individual growing directions of the respective existing personnel.

The personnel fostering plan summarizes the individual growing directions set to the respective existing personnel similar to that in the personnel fostering plan forming system. The personnel dispatching plan proposes dispatch personnel necessary for executing the personnel fostering plan. These plans are made effective by being acknowledged by the organization and held in the data base. Further, the processing means 1 makes individual plans indicating the respective individual growing directions to the respective existing personnel.

The data base unit 2 is stored with capability items for assessing the registered personnel, information of registering a predetermined number of dispatch personnel and information with regard to the plan acknowledged by the organization other than the acknowledged plan.

FIG. 14 shows an outline of a processing executed by the personnel dispatching system.

Similar to the personnel fostering plan forming system, the system also acquires the business pattern 3 representing current mission and future vision of the organization and calculates the current and future necessary personnel amount 4 and the necessary capability amount 5 from the acquired information. Further, with regard to the existing personnel in the respective organization, the system acquires the assessment information 6 of respective capabilities and the information 7 with regard to future images thereof, thereafter calculates the accumulated capability amount 8a and anticipated accumulated capability amount 8b and compares the accumulated capability amounts 8a and 8b with the necessary capability amounts 5a and 5b of the organization.

Further, the system sets the individual growing directions of the respective existing personnel by using the comparison result 9 and makes the plan 11 proposed to the organization. Further, the system searches the data base unit 2 based on the comparison result 9 and samples personnel for supplementing capabilities deficient currently or in the future in the organization. Further, although not illustrated here, the plan 11 includes a personnel dispatching plan based on a result 80 of sampling dispatch personnel and by acknowledging the plan by the organization, there are dispatched personnel P based on the result of sampling the dispatch personnel to the organization as supplementary personnel.

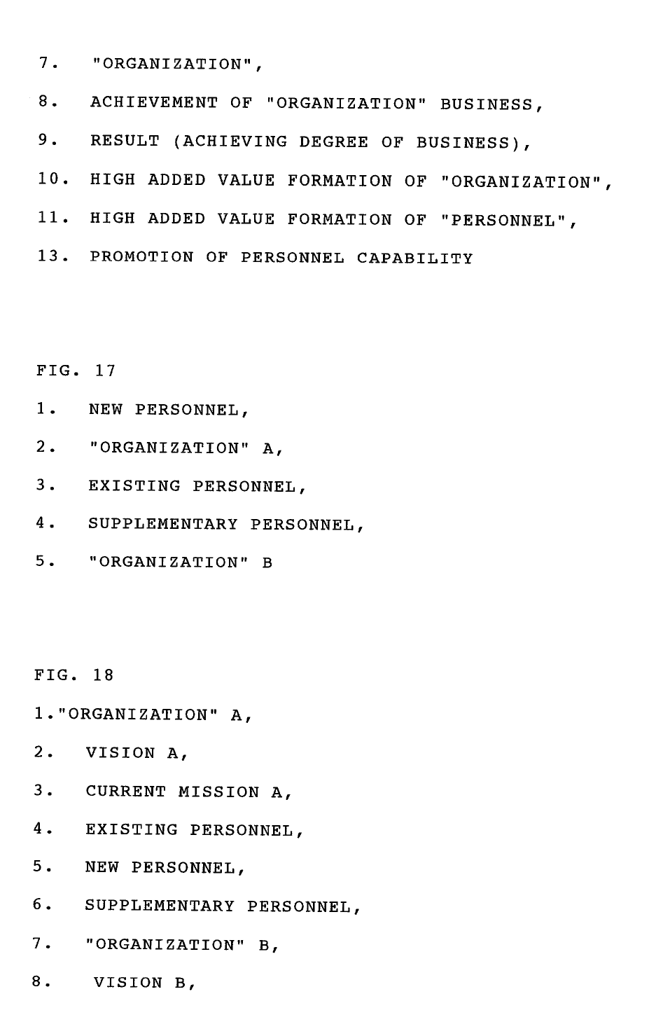

FIG. 15 shows an outline of a processing of calculating yield charged to the organization in the personnel dispatching system.

In FIG. 14, information such as the necessary capability amount 5 acquired in starting the service, the accumulated capability amount 8a and the anticipated capability amount 8b, is stored to the data base unit 2. At a time point at which the personnel fostering period has elapsed, the system acquires new assessment information 12 of capabilities of the existing personnel again and accumulates thereof according to kinds of capabilities. Further, new accumulated capability amount 13 thereof is compared with previous accumulated capability amount 14 stored to the data base unit 2 and determines yield 16 in accordance with a comparison result 15 thereof.

Further, the newly provided accumulated capability amount 13, the result 15 of comparing new and old accumulated capability amounts and the determined yield 16 are held in the data base unit 2.

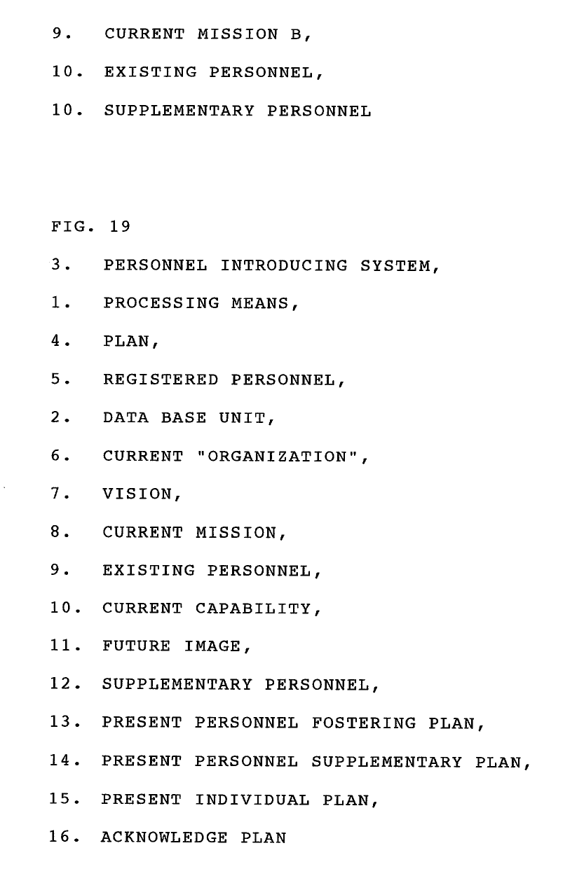

As shown by FIG. 16, the yield set by the above-described processing includes yield in accordance with a degree of achieving business in charge by the dispatch personnel as well as yield in accordance with a degree of contributing to high added value formation of the organization by various plans proposed by the system and the dispatch personnel. Further, the high added value formation of the organization indicates that the capability of the total of the organization is promoted mainly by promoting the capabilities of the existing personnel.

Further, the above-described constitution of the personnel dispatching system is applicable also to business providing service as outside order. In this case, there is sampled business in accordance with capabilities deficient in an organization and the business is proposed to the organization in place of dispatch personnel.

\mathring{3} Personnel Introducing System

FIG. 17 shows an example of a conventional personnel introducing system.

The personnel introducing system of the illustrated example acquires a condition with regard to a personnel needed by an arbitrary organization from the organization, searches a personnel having a capability in accordance with the condition from personnel in an organization different from the above-described organization and introduces the personnel as a supplementary personnel to the organization. Depending on cases, as illustrated, there causes a case in which personnel belonging to two organizations are switched therebetween. Further, when a personnel in accordance with a desired condition of an organization is not found, an outside new personnel is employed.

Further, the new personnel is a personnel who does not belong to any organization and constitutes an object of supplement when a supplementary personnel cannot be ensured between organizations. As the new personnel, for example, there is pointed out a registered personnel of the personnel dispatching company, a working student or a newly employed personnel.

Similar to the conventional type personnel dispatching system shown in FIG. 9, the above-described personnel introducing system selects supplementary personnel in accordance with request on the side of an organization. Further, in many cases, no consideration is given to the change in a capability of holding with regard to an organization on the side of providing a supplementary personnel and therefore, there may be caused significant trouble in managing the organization after the personnel is removed.

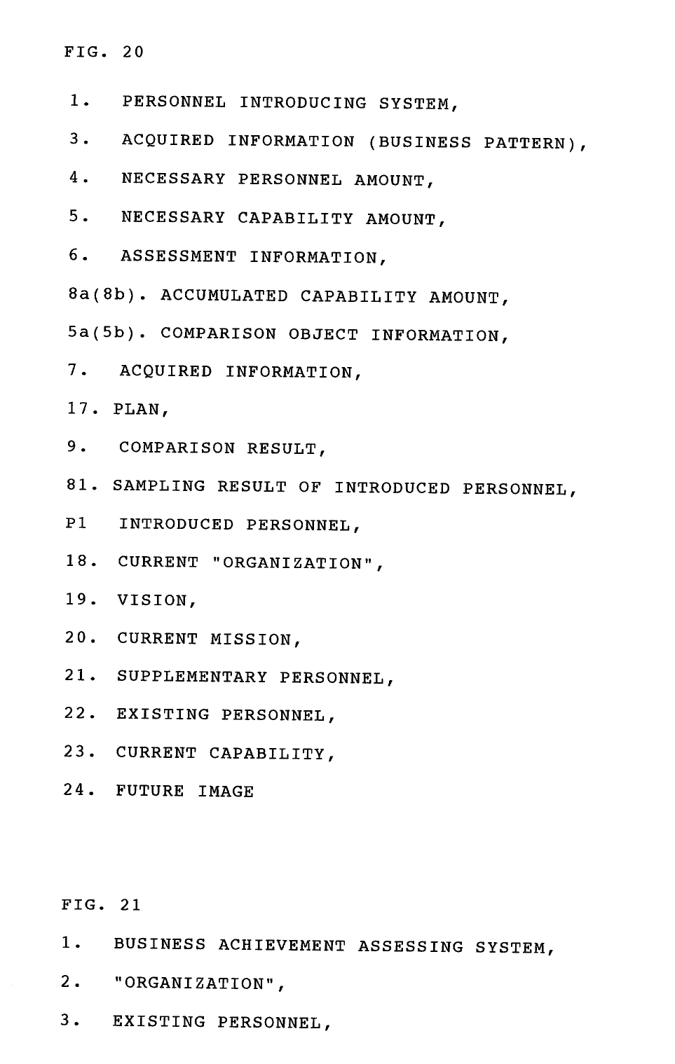

FIG. 18 shows an example of a personnel introducing system to which the invention is applied.

According to the system, there are determined excess or deficiency states of capabilities of the plurality of organizations and when there is a capability deficient in executing mission and vision of a certain organization, there is sampled a personnel supplemented to the former organization from an organization which does not need the capability or an organization in which the capability constitutes an excess.

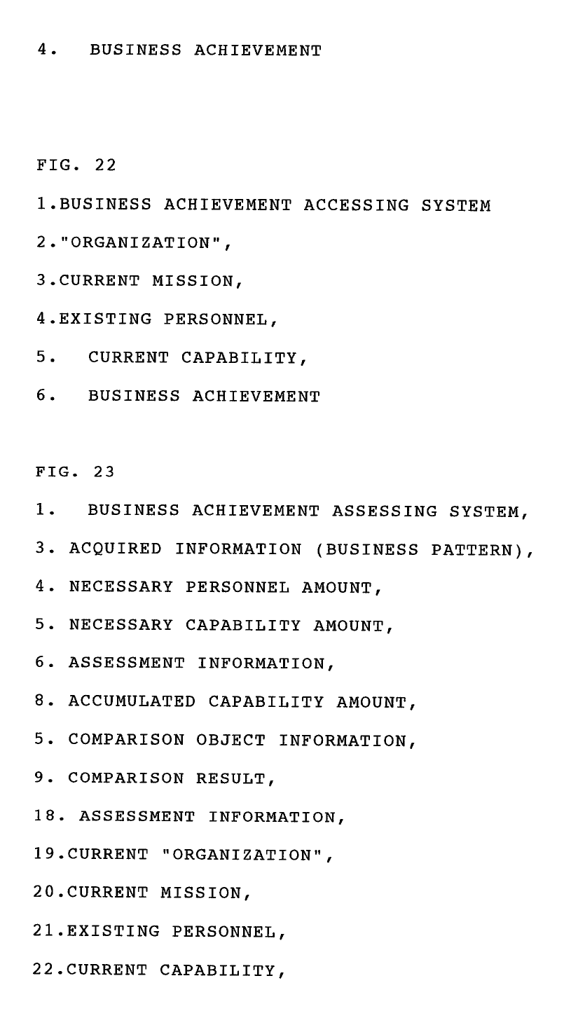

FIG. 19 shows a relationship between the personnel introducing system and an organization.

The system is also provided with the processing means 1 and the data base unit 2 similar to those in the personnel dispatching system and the data base unit 2 is registered with profiles including information with regard to capabilities and future images with regard to exiting personnel of respective organizations. The processing means 1 makes personnel fostering plans and individual plans similar to those in the above-described two systems by using information with regard to current missions and visions of the organizations and information with regard to capabilities and future images of respective personnel and presents thereof to the organizations and the respective personnel. Further, the processing means 1 determines excess or deficiency states of capabilities in the respective organizations from acquired information with regard to the respective organizations and samples a personnel to be supplemented to the organization deficient of the capability from the organization in which the deficient capability constitutes an excess. Further, there is made and presented a proposal with regard to the supplementary personnel (hereinafter, referred to as “personnel supplementing plan”) to both of the organizations constituting supplement destination and supplement origin.

FIG. 20 shows an outline of a processing in the personnel introducing system. Similar to the personnel fostering plan forming system or the personnel dispatching system, the system also acquires the business pattern 3 representing current mission and future vision of the organization of the respective organization and calculates the necessary personnel amounts 4 and the necessary capability amount 5 at present and in the future from the acquired information. Further, the system acquires the information 7 with regard to the assessment information 6 and the future images of the respective capabilities with regard to the existing personnel in the respective organizations, thereafter calculates the accumulated capability amounts 8a and the anticipated accumulated capability amounts 8b and compares the accumulated capability amounts 8a and 8b and the necessary capability amounts 5a and 5b of the organization.

Further, the system determines the organization which needs to supplement personnel by using the comparison results 9 and thereafter samples a personnel to be introduced to the organization from the data base unit 2. Further, by using the comparison result 9 and a result 81 of sampling the introduced personnel, the system makes a plan 17 of personnel supplement to the respective organization or to the personnel constituting the object of supplement.

When the plan is acknowledged, the introduced personnel P1 based on the result 81 of sampling, is assigned to the organization constituting introduction destination as a supplementary personnel to the organization.

According to the above-described personnel introducing system, by supplementing the excess or deficiency states of respective capabilities between the organization, personnel can be supplemented efficiently. Further, there can be provided the organization suitable for the capability and the future image of the respective personnel and the business in accordance with capability and interest thereof to the respective personnel.

Further, also according to the system, the processing can be carried out without using information with regard to future vision or future image of personnel. In this case, personnel belonging to the respective organizations are adjusted in accordance with current excess or deficiency states of capabilities in the respective organizations and there can be set a balanced state of distributing capabilities in executing current missions in the respective organizations.

Further, the above-described personnel introducing system can be used not only by the personnel introducing company but also by a personnel department of a company for the purpose of personnel reshuffling. In this case, the plan 17 can be formed as unofficial information of reshuffling to a personnel.

\mathring{4} Business Achievement Assessing System

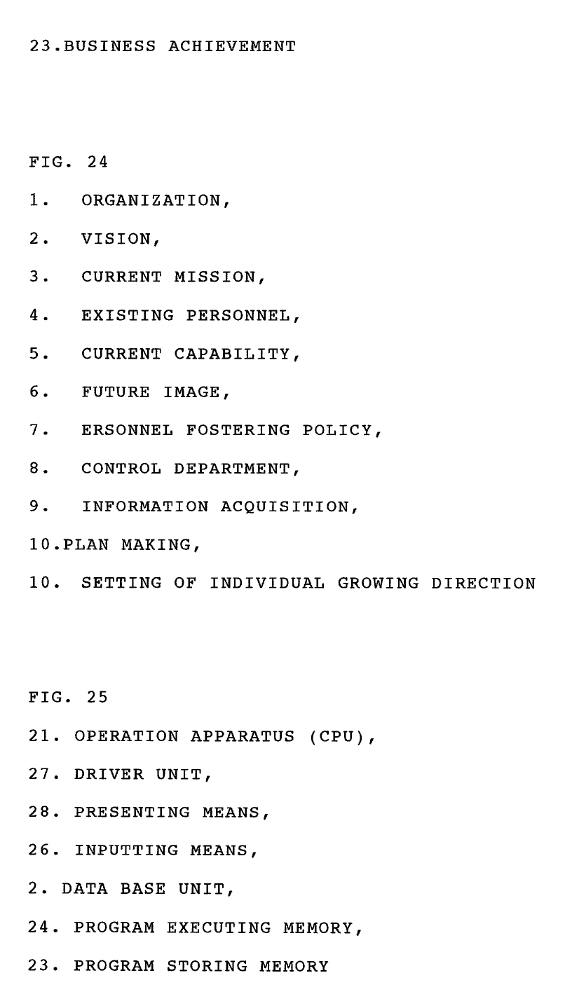

FIG. 21 shows a conventional example of business achievement assessing system.

The business achievement assessing system assesses business achievement of existing personnel in an organization based on a predetermined determination reference and presents evaluation values indicating a result of the assessment to the organization or the personnel per se. Further, the assessment of the business achievement is carried out by checking answer of a personnel per se or a superior with regard to a predetermined number of questions set with regard to business in charge of the respective personnel with the determination reference.

The system of this kind is used by a controller or a personnel department of the organization as well as higher management. Further, the system can also be used by an exclusive support company constituting outsourcing business by the assessment of the business achievement of the respective personnel.

However, according to the system of FIG. 21, importance is given to a degree of achieving business in charge with regard to individual personnel and no consideration is given to a relationship between the excess or deficiency degree of capabilities in the organization and capabilities of respective personnel. Therefore, there is not carried out assessment which changes the determination reference by a case in charge of business which can be executed simply by the organization and a case in charge of business which is very difficult for the organization.

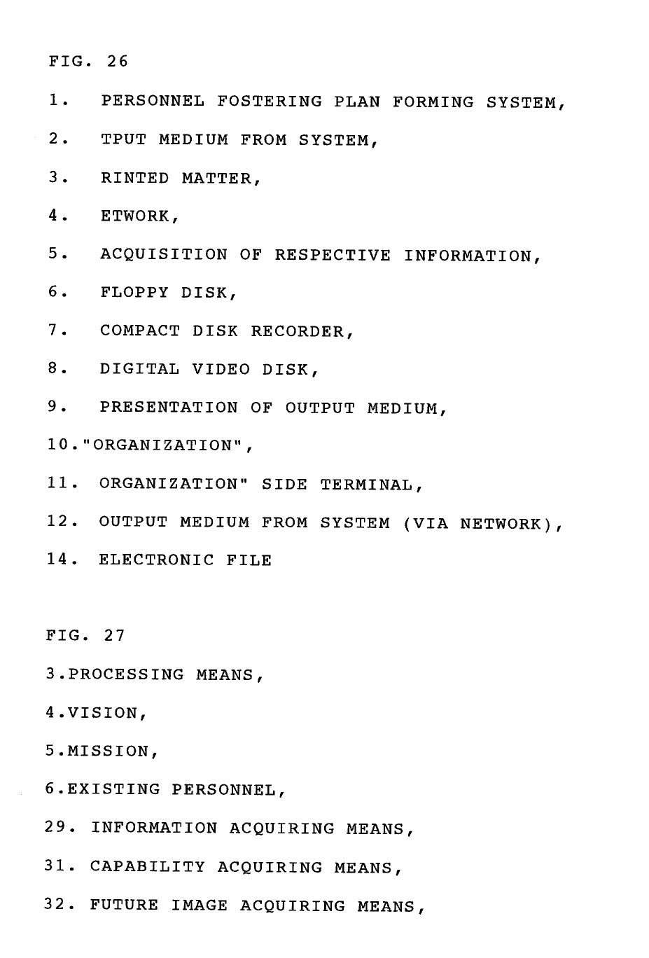

FIG. 22 shows an outline of a business achievement assessing system to which the invention is applied.

The business achievement assessing system assesses business achievement of existing personnel in an organization based on a predetermined determination reference and deduces an excess or deficiency degree of capabilities of the organization in executing mission from the mission of the organization and assessment information of capabilities of respective existing personnel. Further, by adding the excess or deficiency degree to a result of the assessment of the business achievement, there is carried out the business assessment reflecting strong points and weak points of the organization.

FIG. 23 shows an outline of a processing of a business achievement assessing system. According to the system, with regard to present mission, similar to the above-described respective systems, the current business pattern 3 of the organization is acquired and the necessary personnel amount 4 and the necessary capability amount 5 necessary for achieving the mission are calculated from the acquired information. Further, also with regard to capabilities of existing personnel, similar to the above-described respective embodiments, after acquiring the assessment information 6 of capabilities provided to respective personnel, the accumulated capability amount 8 is obtained by accumulating capability amounts of the respective personnel for respective kinds and is compared with the necessary capability amount 5.

Further, the system acquires information with regard to business achievements of respective existing personnel as a result of evaluating achievements of business in charge of the respective personnel by the personnel per se or superiors or both.

The business achievement assessing system specifies the comparison result 9 between the necessary capability amount 5 and the accumulated capability amount 8 added with the acquiring information of the business achievement as final assessment information 18 and presents thereof to the organization.

That is, the system adjusts an evaluation value of the business achievement of the respective business by whether the organization is sufficiently provided with capabilities necessary for the business or the capabilities are deficient. For example, with regard to business using a capability which is deficient for the organization, the business achievement is evaluated by a determination reference which is more liberal than normal evaluation standard and on the other hand, with regard to business achieved by a capability sufficient for the organization, the business achievement is evaluated by a determination reference severer than normal standard. By such an assessment method, there can be carried out business assessment reflecting a contribution degree achieved by respective personnel achieving particularly difficult business in the organization and the business achievement of the respective personnel can properly be evaluated without depending on experience or perception of a controller or a person in charge of personnel affairs.

Further, although according to the above-described business achievement assessing system, the excess or deficiency degree of the capability of the organization is determined by using information indicating current mission, the invention is not limited thereto but particularly when business achievement over a predetermined time period is assessed, by also using information with regard to business finished in the time period, there may be determined the excess or deficiency degree of capabilities of the organizations with regard to all of business executed in the period and a result of the determination may be reflected to business achievement of respective personnel.

Further, when user of the system is a controller of an organization or a personnel department, the assessment information can not only be presented to the organization but also to respective individual personnel.

### EXAMPLES

An explanation will be given of procedures of specific constitutions and processings with regard to the above-described four kinds of systems successively as follows.

### \mathring{1} Example 1

### Personnel Fostering Plan Forming System

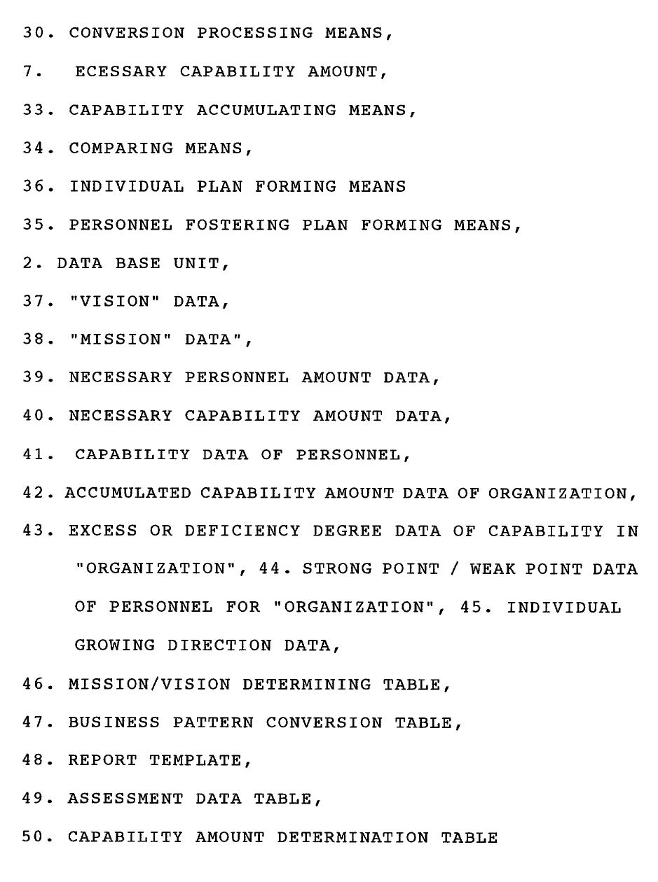

FIG. 24 shows a relationship between an organization and a control department when the control department such as a personnel department uses the personnel fostering plan forming system.

The control department sets individual growing directions of respective personnel from information with regard to current mission and vision of the organization as well as information with regard to capabilities and future images of respective existing personnel and forms a personnel fostering plan with regard to a total of the organization from the individual growing directions of the respective existing personnel by using the personnel fostering plan forming system. The formed personnel fostering plan is presented to the organization and the organization determines a policy of fostering the respective existing personnel based on the plan. Further, individual plans indicating individual growing directions of respective personnel are presented from the control department to the respective existing personnel.

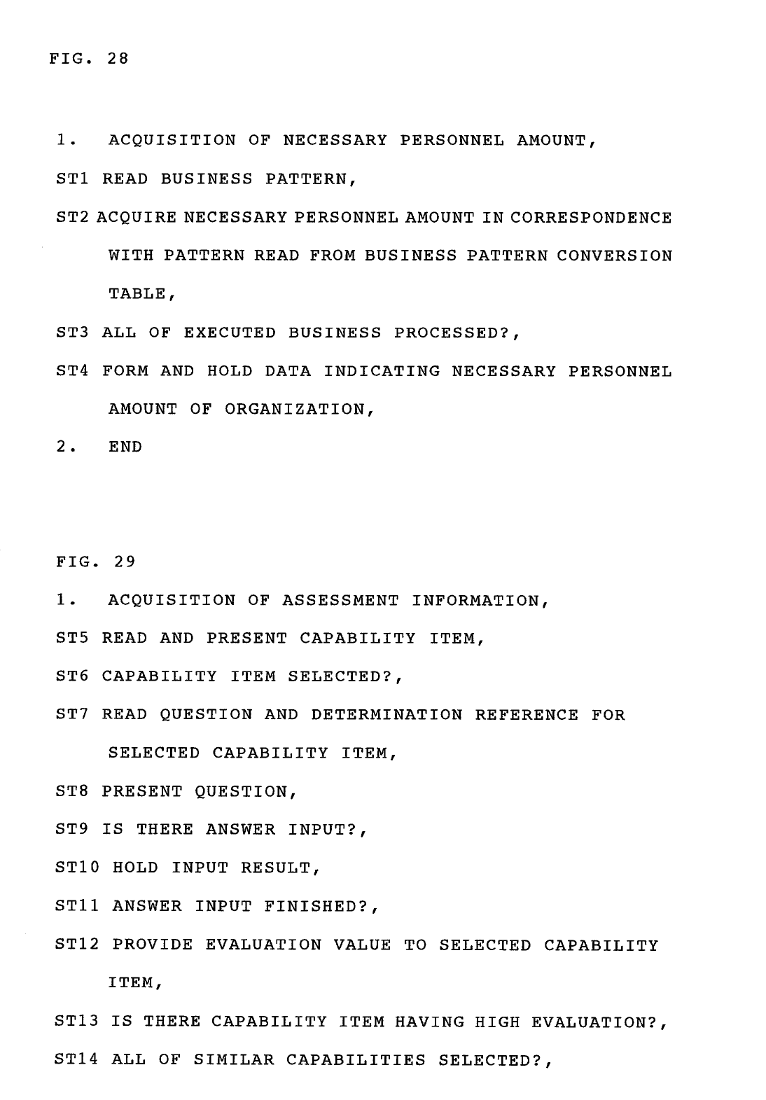

FIG. 25 shows a hardware constitution of a computer for realizing the personnel fostering plan forming system.

The computer 20 is constituted mainly by an operation apparatus (CPU) 21 constituting a main body of control and a memory 22. The memory 22 includes the data base unit 2 as well as a program storing memory 23 for providing the operation apparatus 21 with a function as a processing unit of the system and a program executing memory 24 as a work area in executing the program.

The operation apparatus 21 is connected with means 26 for inputting the mission and the vision as well as individual information (capability and future image) with regard to respective existing personnel (hereinafter, simply referred to as “inputting means 26”) via an interface 25 and means 28 for presenting the personnel fostering plan or individual plans to the organization or respective personnel (hereinafter, simply referred to as “presenting means 28”) via a driver unit 27 for outputting information.

There can respectively be pointed out a keyboard and a printer as representative ones of the inputting means 26 and the presenting means 28. However, the inputting means 26 can also be constituted by a mouse or an optical reading apparatus and the presenting means 28 can also be constituted by a facsimile apparatus.

Further, as shown by FIG. 26, when exchange of information between the organization and the system is carried out by using a record medium such as FD, CD-R or DVD, the inputting means 26 and the presenting means 28 can be integrated as a drive apparatus for a record medium used. Further, when the organization and a control department are connected by a network, the inputting means 26 and the presenting means 28 are integrally constituted by the network and transmitting/receiving circuits of input/output signals.

Further, the hardware constitution is not limited to the personnel fostering plan forming system but is adapted to respective systems of a personnel dispatching system, a personnel introducing system and a business achievement assessing system, mentioned later.

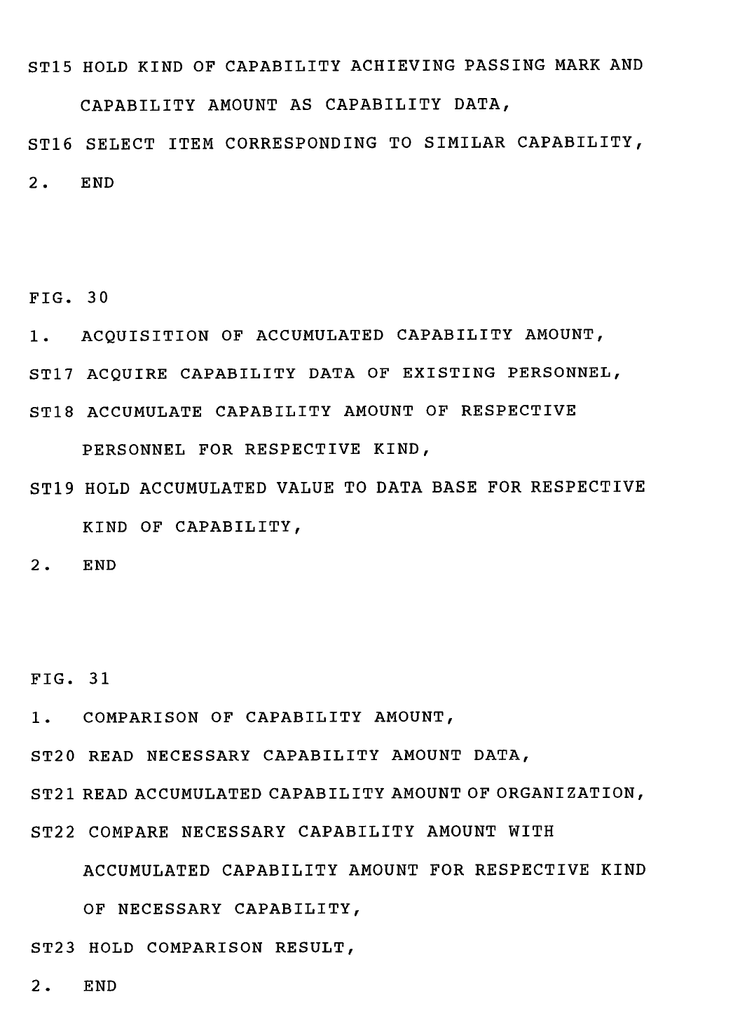

FIG. 27 shows a specific constitution of the personnel fostering plan forming system.

The data base unit 2 is set with regions 37 through 45 for storing data with regard to mission and vision of the organization, necessary personnel amount data, necessary capability amount data, capability data of respective existing personnel, accumulated capability amount data of the organization, excess or deficiency degree data of capabilities in the organization, strong point/weak point data of respective personnel for the organization and individual growing direction data as information formed in input information and procedures of processings. Other than these, the data base unit 2 is stored with a mission/vision determining table 46, a business pattern conversion table 47, a report template 48, an assessment data table 49 and a capability amount determination table 50 for a processing of converting input information and forming plans.

In the drawing, processing means 1 is realized by the operation apparatus 21 executing programs in the program storing memory 23 and includes means such as information acquiring means 29, conversion processing means 30, capability acquiring means 31, future image acquiring means 32, capability accumulating means 33, comparing means 34, personnel fostering plan forming means 35 and individual plan forming means 36.

The information acquiring means 29 receives input of information with regard to mission and vision of the organization and acquires business content and business target at present and in the future of the organization. The capability acquiring means 31 receives input of information indicating capabilities of respective existing personnel and deduces kinds of capabilities currently held by respective personnel and capability amount thereof. The future image acquiring means 32 receives input of information with regard to future images of respective existing personnel and deduces kinds of capabilities having possibilities of being held by respective personnel in the future and capability amounts thereof.

Further, in the following explanation, with regard to the kinds of the capabilities and the capability amounts of the respective existing personnel, data at present and future is summarized to be referred to as “capability amount data”.

The conversion processing means 30 deduces necessary capability amounts at present and in the future of the organization from acquired information with regard to the mission and the vision. The capability accumulating means 33 calculates the accumulated capability amount and the anticipated accumulated capability amount, mentioned above, from the capability amount data of the existing personnel. The comparing means 34 samples the excess or deficiency degrees of capabilities in the organization by comparing the accumulated capability amount and the anticipated accumulated capability amount respectively with necessary capability amounts at present and in the future for the respective kinds of capabilities.

The individual plan forming means 36 forms data indicating strong points and weak points of individuals with regard to capabilities necessary for the organization (hereinafter, referred to as “strong point/weak point data”) based on the capability amount data of the respective existing personnel. Further, the individual plan forming means 36 sets individual growing directions of the respective personnel by using the strong point/weak point data and the excess or deficiency degrees of capabilities in the organization sampled by the comparing means 34 and forms individual plans of the respective existing personnel based on the set data.

The personnel fostering plan forming means 35 forms a personnel fostering plan of the organization by using processing results by the information acquiring means 29 and the conversion processing means 30 and the individual growing directions of the respective existing personnel set by the individual plan forming means 36.

Further, the storing region 48 of the report template of the data base unit 2, is held with electronic data indicating patterned documents as well as programs for deriving data fitted to blank portions of the patterned documents from data such as individual growing directions with regard to the personnel fostering plan and the individual plans.

An explanation will be given successively of details of processings by respective means in the processing means 1 and data constitution in the data base unit 2 related to the respective means as follows.

The information acquiring means 29 inputs, as information with regard to the mission and the vision, information based on a result of, for example, presenting a questionnaire to and carrying out an interview with the organization and information in a style of a result of answer on the side of the organization to a predetermined number of questions. Although with regard to the data input, there is a case of inputting information obtained previously from the questionnaire or hearing by a paper medium on the side of a control department, when the inputting means 26 is constituted by a record medium or a network, the information can be inputted directly on the side of the organization.

The mission/vision determining table 46 in the data base unit 2 determines content of business and business object from answer pattern included in input information with regard to the mission and the vision. For determining the business content, there is set a business table corresponding a plurality of kinds of business to code information. Further, for determining the business target, there is set a conversion table for deriving business amounts for respective predetermined time period from answer pattern with regard to a predetermined number of questions with regard to the business target for respective kinds of business.

The information acquiring means 29 determines the business content and the business target at present and in the future in the organization from input information with regard to the mission and the vision by using the mission/vision determining table 46. Further, combinations of the business content and the business target determined, that is, the business pattern is held in the respective data storing regions 37 and 38 of the mission and the vision of the data base unit 2.

Further, the mission is frequently derived from a middle term or a long term scheme and therefore, there is a case in which information with regard to the vision is included in information inputted as information with regard to the mission.

The business pattern conversion table 47 is set with necessary personnel amounts for realizing various kinds of business patterns in correspondence therewith based on the concept shown in FIG. 4. The conversion processing means 30 acquires necessary personnel amounts of the organization at present and in the future by fitting the business patterns provided with regard to the mission and the vision to the business pattern conversion table 47.

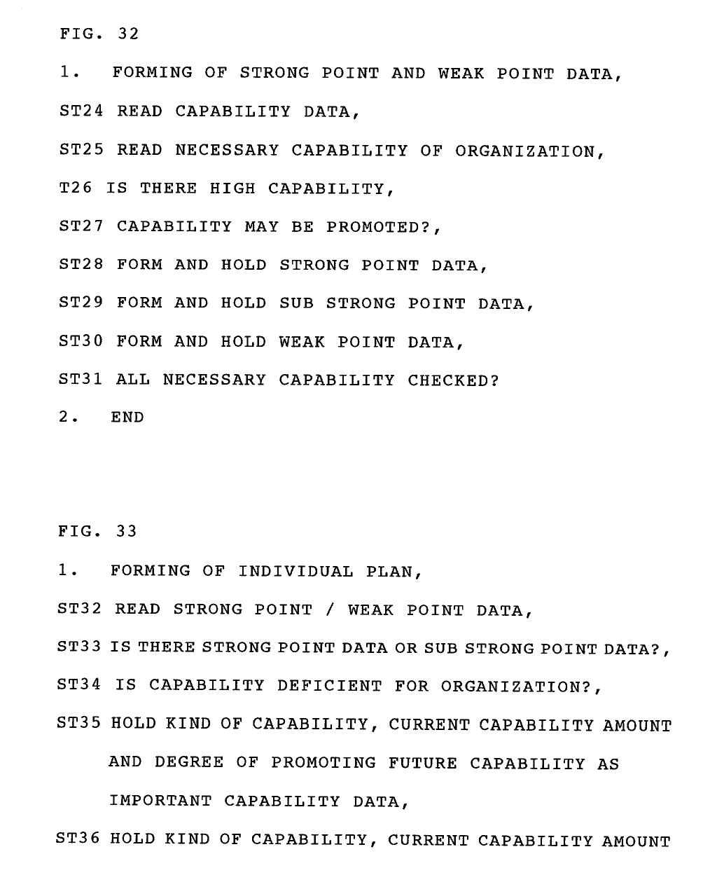

FIG. 28 shows a processing procedure of the conversion processing means 30. Further, although in the following, an explanation will be given by assuming a case of acquiring a current necessary personnel amount by using the business pattern of the “mission”, also with regard to a future necessary personnel amount, a necessary personnel amount can be acquired by carrying out a similar processing by using the business pattern of the “vision”.

As described above, the mission of the organization is normally established by executing a plurality of business. The conversion processing means 30 reads business pattern with regard to respective business from the storing region 38 of the “mission” data of the data base unit 2 at initial ST1. Thereafter, in a loop of ST2 and ST3, there is successively acquired necessary personnel amounts in correspondence with the respective business patterns from the business pattern conversion table 47. Further, finally, at ST4, there is formed data corresponding information representing kinds of business to necessary personnel amounts for respective business and thereafter, an aggregation of the data is stored to the data base unit 2 as a necessary personnel amount of the organization.

Further, after the above-described processing, the conversion processing means 30 replaces the necessary personnel amount by the necessary capability amount and stores thereof to the data base unit 2.

Next, an explanation will be given of acquisition of capability data of existing personnel.

According to the example, there is inputted information showing a result of answer by personnel per se or superiors to the plurality of items of questions for measuring capability amounts of various kinds of capabilities (in the following, an explanation will be given such that the personnel per se answer thereto). The assessment data table 49 is set with contents of various kinds of questions for measuring capabilities represented by a plurality of capability items for respectives thereof and the capability amount determination table 50 is set with determination references for specifying capability amounts from answer patterns with regard to the respective questions. The capability acquiring means 31 deduces kinds of capabilities held by the existing personnel and capability amounts thereof by fitting the inputted answer patterns of the respective existing personnel to the determination references.

FIG. 29 shows a processing procedure of acquiring information with regard to capabilities of the respective existing personnel by the capability acquiring means 31. Further, although the illustrated example is on the premise that the inputting means 26 is constituted by the network connected to the computer on the side of the organization, the questions are directly presented to the existing personnel and answers with regard to the respective questions are directly inputted, the questions may be presented by a paper medium and the answers may be inputted by the side of the control department. Further, a record medium recorded with the answers may be inputted to the system and record information may be read thereby.

In the procedure of FIG. 29, portions of “headings” of respective capability items are firstly read from the assessment data table 49 and presented to respective personnel by a method of displaying the content on a monitor screen of the computer on the side of the organization (ST5).

The “headings” are character information representing kinds of capabilities (for example, scheming capability, information analyzing capability, negotiating capability) and are added with information for explaining contents of capabilities as necessary. In this case, by presenting the respective capability items, capabilities which seem to adapt to personnel per se are selected by the personnel.

When the predetermined number of capability items are selected, the operation proceeds from ST6 to ST7 and reads questions and determination references with regard to the selected respective capability items from the assessment data table 49 and the capability amount determination table 50 of the data base unit 2. Further, at successive ST8, the read respective questions are presented on the monitor screen and answer input on the side of the personnel is awaited. Further, at every time of inputting answer to question, operation proceeds to from ST9 to ST10 and temporarily holds content of inputted answer to the program executing memory 24.

When answer inputs with regard to all of the presented questions have been finished, the operation proceeds from ST11 to ST12 and derives predetermined evaluation values by fitting answer patterns of the respective selected capability items to the determination references. The evaluation values obtained in the way are temporarily stored to the program executing memory 24 as capability amounts with regard to respective capability items.

At successive ST13, the evaluation values of the respective capability items are checked. Further, when there are items achieving evaluation values equal to or higher than predetermined level values, at ST14, it is checked whether capabilities similar to the capability indicated by the capability item are also selected and when there is an item which is not selected, the item is selected at ST16. Further, by executing similarly the processings of ST7 through ST12 with respect to the selected capability item, there is acquired an evaluation value indicating a capability amount with regard to the capability item.

In this way, firstly, the capability amounts with regard to the capability items selected by the personnel are checked and thereafter, with respect to a capability item indicating high capability, there is checked the capability amount of the capability item similar to such item. When determination at ST13 is “NO” or when determination at ST14 is “YES”, the operation proceeds to ST15 and specifies a capability with regard to an item in which an evaluation mark reaches a passing mark in the respective capability items, as the capability of the personnel. Further, there is formed data combining the kind of capability used in “heading” of the respective item and the capability amount achieved as the evaluation mark for the respective capability item achieving the passing mark and the data is held in the region 41 of the data base unit 2 as the capability data of the personnel.

Further, the assessment data table 49 and the capable amount determination table 50 include determination references for specifying questions and capability amounts for measuring not only current capabilities but also future capabilities. The future image of the existing personnel is inputted as a result of answer of the existing personnel or a superior to the questions and by the procedure similar to that of FIG. 29, the future image acquiring means 32 samples kinds of capabilities having high possibilities of being held by the personnel in the future from the answer pattern of the respective personnel and the capability amount thereof and holds a result of the sampling to the data base unit 2 as future capability data of the personnel.

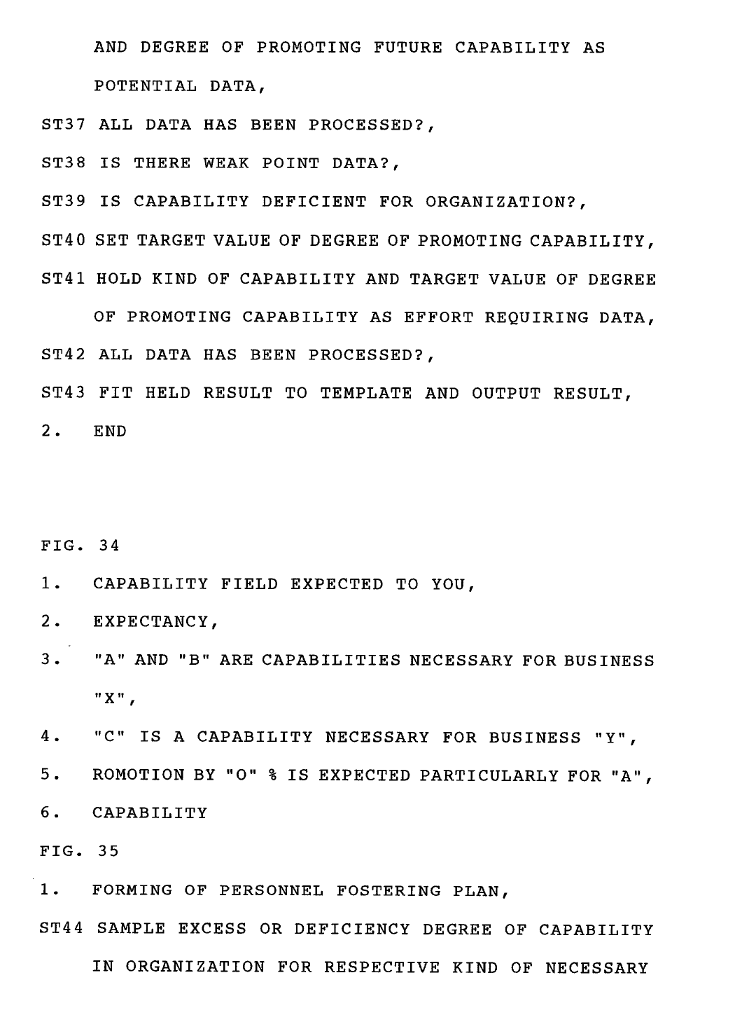

FIG. 30 shows a procedure of processing by the capability accumulating means 33. Further, although in this case, an explanation will be given by assuming to accumulate current capability amounts, a similar procedure is executed also in the case of accumulating future capability amounts.

At ST17 of FIG. 30, the capability accumulating means 33 reads the capability data provided by the procedure of FIG. 29 with regard to respective personnel. Further, at successive ST18, respective capability amounts are accumulated for respective kinds of capabilities and thereafter, at successive ST19, there is formed data corresponding accumulated values of capability amounts to respective kinds of capabilities. The data is held in the region 42 of the data base unit 22 as accumulated capability amount data at present. Further, although not illustrated here, capabilities constituting objects of the accumulating processings may be limited to capabilities registered as capabilities necessary for the mission or the vision.

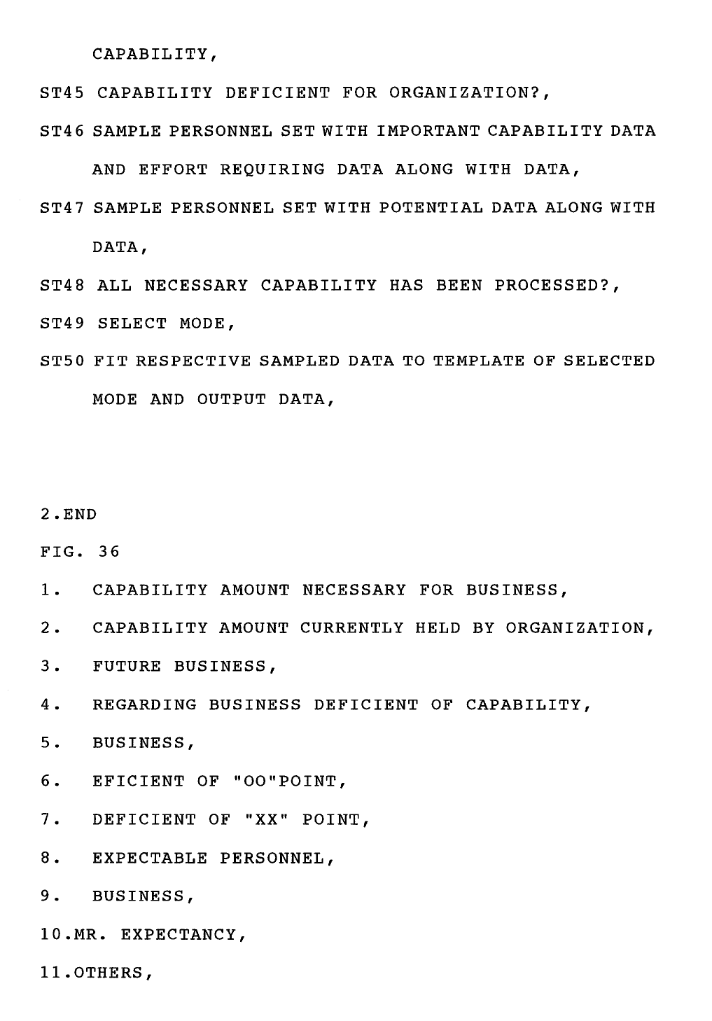

FIG. 31 shows a processing procedure of the comparing means 34. Further, although an explanation will be given by assuming the case of comparing the current accumulated capability amount with the necessary personnel amount also in the drawing, comparison between the future anticipated accumulated capability amount and the necessary personnel amount is carried out similarly.

At ST20 and ST21 of FIG. 31, the comparing means 34 reads the necessary capability amount data and the accumulated capability amount data respectively from the data base unit 2. Further, the operation compares the accumulated capability amount and the necessary capability amount for respective kinds of capabilities shown by the necessary capability amount data (ST22).

At successive ST23, based on a result of the comparison, there is formed information combined with kinds of necessary capabilities and numerical data indicating excess or deficiency degrees of capability amounts and the data is made to constitute excess or deficiency degree data of capabilities of the organization and is held in the region 43 of the data base unit 2.

FIG. 32 shows a processing procedure in the case of forming strong point and weak point data of the respective existing personnel by the individual plan forming means 36. Further, in this case, there is shown a data forming method with regard to one personnel and it is necessary to repeat the procedure of FIG. 32 for the respective personnel of the organization.

At initial step ST24 of the processing, capability data of the personnel, that is, kinds of capabilities at present and in the future and capability amounts thereof are read, further, at successive ST25, there are acquired kinds of necessary capabilities in the organization from the necessary capability amount data. Further, the following processing is executed for the respective kinds of necessary capabilities.

At ST26, with regard to predetermined necessary capability, the current capability amount of the existing personnel is compared with a predetermined reference value. When the capability amount of the existing personnel is superior to the reference value, it is determined that the personnel is provided with high capability with regard to the necessary capability and the operation proceeds to ST28. At ST28, there is set data indicating the kind of the necessary capability to which attention is paid, the capability amount held by the personnel with regard to the necessary capability and a degree of promoting future capability, as “strong point data” of the personnel and the data is held in the region 44 of the data base unit 2.

Meanwhile, when determination at ST26 is “NO”, the operation proceeds to ST27 and compares the degree of promoting capability provided by comparing the current capability amount of the personnel with the future capability amount thereof, with a predetermined reference value with regard to the necessary capability. When the promoting degree is equal to or higher than the reference value, it is determined that personnel is a personnel having a possibility of promoting the necessary capability and the operation proceeds to ST29, sets data indicating the kind of the necessary capability to which attention is paid, the capability amount held by the personnel with regard to the necessary capability and the degree of promoting the capability, as “sub strong point data” of the personnel and holds the data to the region 44 of the data base unit 2.

Further, when there is not present the capability data in correspondence with the necessary capability to which attention is paid, all of determination ST26 and ST27 are “NO” and the operation proceeds to ST30. At ST30, there is formed data corresponding null code to the kind of the necessary capability to which the attention is paid and data is held in the region 44 of the data base unit 2 as “weak point data” of the personnel.

In this way, with respect to kinds of necessary capabilities of the organization, it is checked to which of strong points and weak points of the personnel, the necessary capabilities correspond and data of any of strong points, sub strong points and weak points are formed and held in the data base unit 2. When data of all the necessary capabilities have finished to be formed and held, the determination of ST31 becomes “YES” and the processing of forming strong and weak data of the existing personnel is finished.

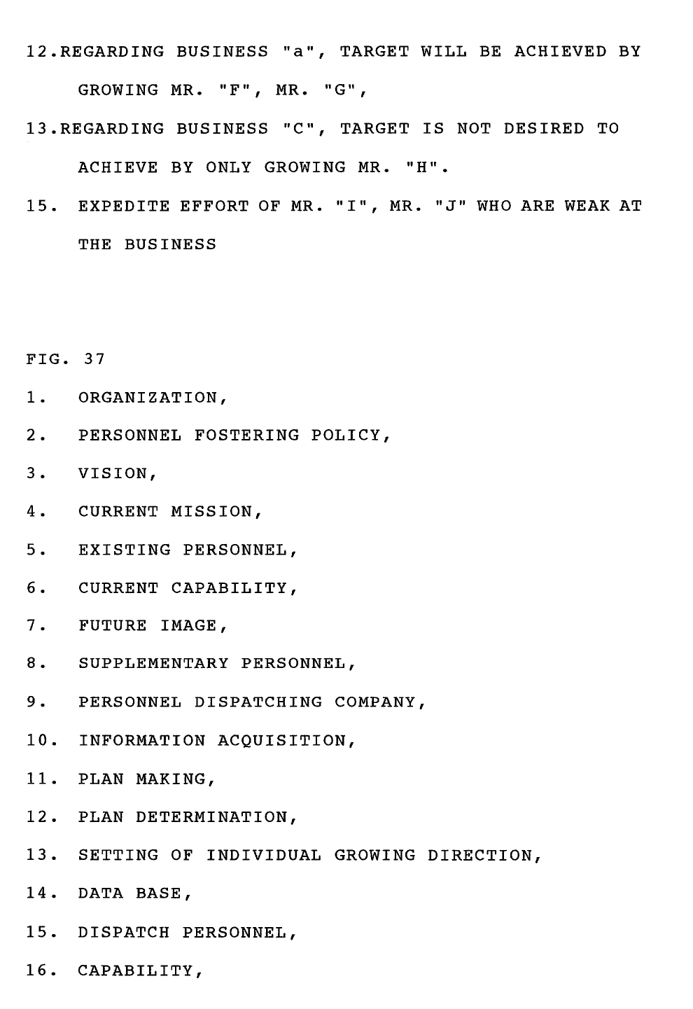

FIG. 33 shows a processing procedure with regard to setting individual growing direction data by the individual plan forming means 36 and forming individual plans by using the data. Further, the drawing also shows a processing procedure with respect to one existing personnel similar to FIG. 32 and in order to form individual plans of all the personnel of the organization, there is repeated the illustrated procedure for respective personnel.

In the illustrated example, as individual growing direction data, there are set three kinds of data of important capability data, potential data and effort requiring data. The data is provided by checking strong point/weak point data of the existing personnel with excess or deficiency degrees of capability of the organization and the important capability data shows that a capability deficient for the organization is held by the existing personnel or that there is a possibility of holding thereof in the future. Meanwhile, the effort requiring data shows that the capability deficient for the organization constitutes a weak point of the existing personnel. Further, the potential data shows that a capability constituting a strong point of the existing personnel or a capability which can constitute the strong point of the existing personnel, is sufficiently ensured for the organization.

At ST32 which becomes a first procedure in FIG. 33, the strong point/weak point data of the existing personnel to which attention is paid, is read. When the read data includes the strong point data or the sub strong point data, determination of ST33 becomes “YES” and there is formed the important capability data or the potential data by processings of ST34 through ST37. Further, when the read data includes the weak point data, determination at ST38 becomes “YES” and the effort requiring data is formed by processings of ST39 through ST42.

With regard to the strong point data and the sub strong data, there are successively carried out the following processings. First, at ST34, it is determined whether a necessary capability in correspondence with data to which attention is paid is a capability deficient for the organization. The determination is carried out based on excess or deficiency degree data of capability provided by comparing the necessary capability amount with the accumulated capability amount and when the capability to which attention is paid is deficient for the organization, the operation proceeds to ST35 and forms the important capability data. Further, when the capability to which attention is paid is sufficient for the organization, the operation proceeds to ST36 and forms the potential data.

Further, either of the important capability data and the potential data is constructed by a constitution corresponding a current capability amount of the personnel and a degree of promoting a future capability provided from the strong point data or the sub strong point data to which attention is paid, to kind of capability and is held in the region 45 of the data base unit 2.

Next, also with regard to the weak point data, similarly, it is checked whether a capability in correspondence with data to which attention is paid at ST39 is a capability deficient for the organization. When the capability is determined to be the deficient capability at the step, the operation proceeds from ST39 to ST40 and sets a target value of a degree of promoting the capability of the existing personnel based on excess or deficiency degrees of capabilities of the organization and a number of the existing personnel.

Further, in acquiring capability data shown in FIG. 29, when a capability amount is acquired with respect to the capability constituting the weak point, a target value in accordance with the capability amount can be set.

When the target value of the degree of promoting the capability is set, at successive ST41, as the effort requiring data, there is formed data corresponding the target value to kind of capability and the data is held in the region 45 of the data base unit 2.

When the growing direction data of the existing personnel is formed in this way, at final ST43, a template for individual plan is read from the storing region 48 of report template of the data base unit 2 and the template is fitted to the growing direction data to thereby form the individual plan for the existing personnel. The formed plan is outputted to the presenting means 28 in an electronic data style and is presented to the existing personnel in a style in accordance with the constitution of the presenting means 28.

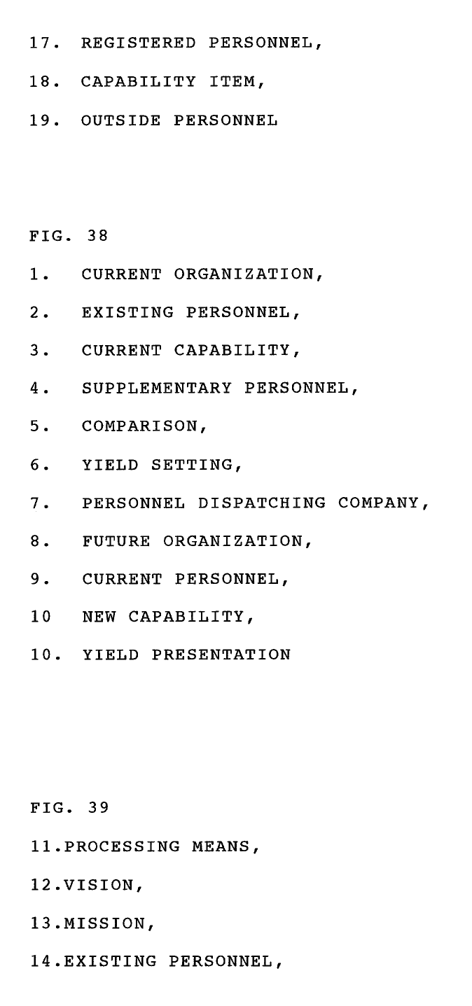

FIG. 34 shows an example of an individual plan outputted to a paper medium. According to the illustrated example, there is shown document data indicating a graph extracting the important capability data and corresponding kinds of capabilities shown by the data to expectancies thereof and to what business respective capabilities relate. Further, dotted line portions in the document data indicate blanks of a patterned document fitted with kinds of capabilities and degrees of promoting capabilities derived from important capability data.

FIG. 35 shows a processing procedure by the personnel fostering plan forming means 35.

According to the processing, first, at initial ST44, excess and deficiency degrees of capabilities are read from the data base unit 2 for respective kinds of necessary capabilities in the organization and thereafter, the following processing is executed for the respective kinds of the necessary capabilities.

At ST45, it is checked whether a capability to which attention is paid is a capability deficient for the organization. Further, when the capability is determined to be the deficient capability, the operation proceeds from ST45 to ST46 and by searching the growing direction data of the respective existing personnel, there is sampled a personnel set with the important capability data and the effort requiring data with respect to the capability along with the data. Further, when the capability is determined not to be deficient, the operation proceeds to ST47, the data base is searched similarly and there is sampled a personal set with the potential data with regard to the capability along with the data.

When the processing of sampling data with regard to all of the necessary capabilities has been finished, the operation proceeds from ST48 to ST49 and there is selected an output mode of the personnel fostering plan. Further, the selection can be carried out not only by receiving selection from outside at the time point or based on previously set selection data. (The same goes with the following examples.)

At final ST50, there is formed electronic data of the personnel fostering plan by fitting the respective data sampled at ST45 through ST48 to the template in correspondence with the selected mode and the data is outputted to the presenting means 28. Further, depending on the selected mode, it is necessary to use not only the sampled data but also various data stored to the data base unit 2 such as the necessary personnel amount, the necessary capability amount or the accumulated capability amount.

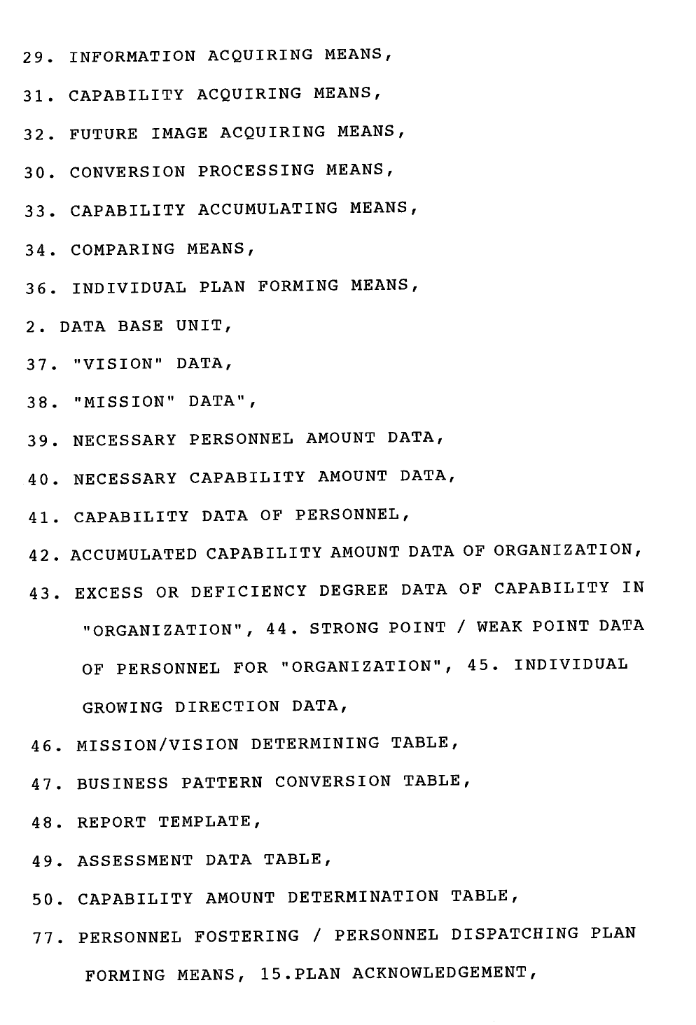

FIG. 36 shows an example of a personnel fostering plan outputted to a paper medium. Further, dotted line portions in the drawing show blank portions in a patterned document.

In the illustrated example, at the head of the plan, there is presented a graph comparing capability amounts necessary for business and current capability amounts of a total of the organization for the respective business to be executed in the future by the organization. Below the graph, there are presented information indicating business deficient of capability and deficient amounts thereof and names of personnel expectably in promoting the deficient capabilities and expectancies. Further, therebelow, there is presented comment information indicating whether future business target can be achieved by growing respective personnel.

Further, the graph is formed based on the necessary capability amount and the accumulated capability amount. Further, the personnel and the expectancies in respective information are sampled by the important capability data and the effort requiring data.

### \mathring{2} Example 2

### Personnel Dispatching System

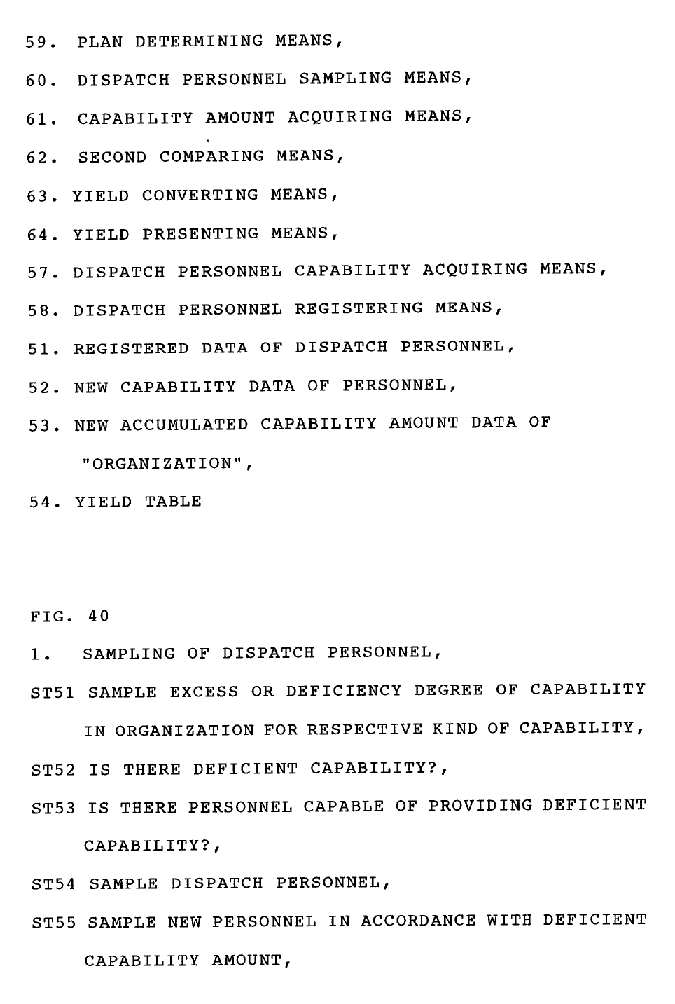

FIG. 37 shows a relationship between a personnel dispatching company using a personnel dispatching system and an organization.

The personnel dispatching company acquires information with regard to current mission and vision from an organization and information with regard to capabilities and future images of existing personnel of the organization, presents a personnel fostering plan for growing the organization toward the vision and presents a personnel dispatching plan for supplementing capabilities deficient for the plan. When the plans are acknowledged by the organization, the personnel dispatching company dispatches personnel in line with the plans and presents individual growing direction in line with the personnel fostering plan to respective existing personnel of the organization. Further, selection of dispatch personnel is carried out by sampling personnel having capabilities of kinds in accordance with the personnel dispatching plan and capability amounts from a plurality of personnel registered in a data base.

Further, the personnel dispatching company charges predetermined yield to the organization in accordance with a degree of realizing the proposed plans. As shown by FIG. 38, the yield is set by acquiring again an accumulated capability amount by the respective existing personnel at a time point at which a predetermined time period such as a proposed personnel fostering time period has elapsed and comparing a new accumulated capability amount with an accumulated capability amount at a time point of presenting the plans. However, it is not necessarily needed to set the yield.

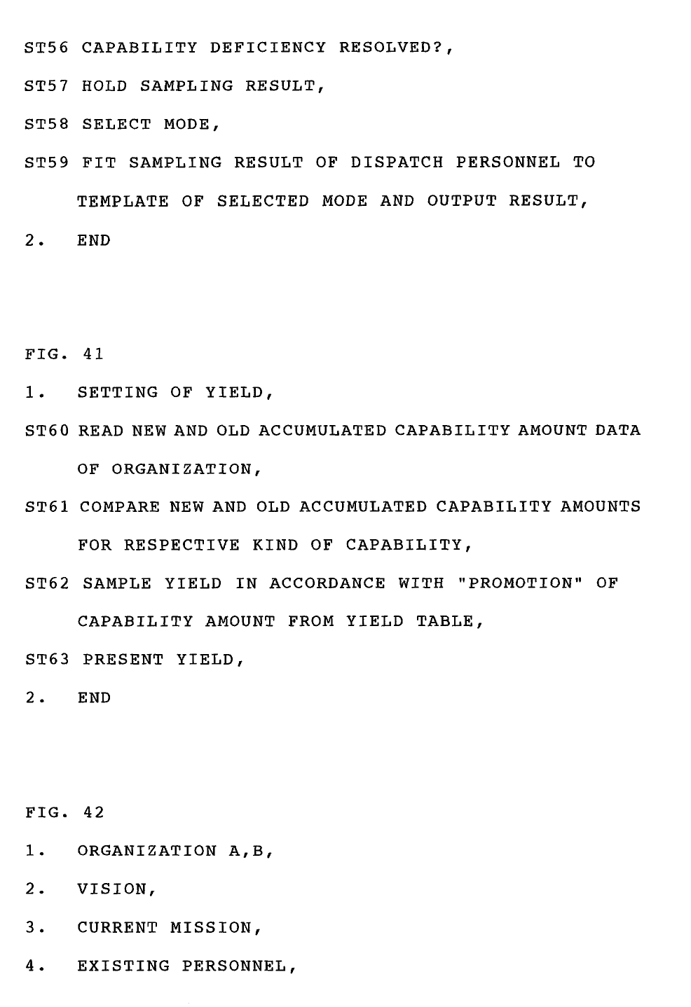

FIG. 39 shows a specific constitution of the personnel dispatching system.

Similar to the first example, the system is also constituted by the processing means 1 realized by the operation apparatus 21 and programs and the data base unit 2.

The data base unit 2 is set with storing regions 51, 52, 53 and 54 of registered data of dispatch personnel, new capability data of personnel, new accumulated capability amount data of organization and yield table in addition to data storing regions similar to those in the first example. Further, the processing means 1 includes respective means of plan determining means 59, yield setting means 55, dispatch personnel capability acquiring means 57 and dispatch personnel registering means 58 other than a constitution similar to that of the first example. Further, a personnel fostering / personnel dispatching plan forming means 77 is set in place of the personnel fostering plan forming means 36 of the first example.

Further, in FIG. 39, constitutions common to those of the first example and processing contents thereof, function similar to the above-described example and therefore, an explanation thereof will be omitted here.

However, according to the example, by inputting again information indicating capabilities of existing personnel after elapse of a predetermined time period from start of service, there are acquired capability data of the existing personnel and an accumulated capability amount of the organization after growth by the capability acquiring means 31 and the capability accumulating means 33. The acquired information is held in the storing regions 52 and 53 of the new capability data of personnel and the new accumulated capability amount data of the organization of the data base unit 2.

The personnel fostering/personnel dispatching plan forming means 77 forms the personnel fostering plan similar to the first example and forms a personnel dispatching plan for proposing dispatch personnel sampled in line with the personnel fostering plan and outputs thereof to the presenting means 28. Further, according to the personnel dispatching plan, there are proposed initial dispatch personnel for supplementing capabilities deficient for the current organization and dispatch personnel in the future for supplementing capabilities still deficient at a time point at which a time period of fostering personnel has been finished and further, personnel for dealing with a deficiency in capabilities at a middle point in the fostering time period and personnel having capabilities for carrying out education necessary for growing the existing personnel in line with the personnel fostering plan as necessary.

The plan determining means 59 processes to determine the plans acknowledged by the organization and starts to process to select dispatch personnel and is provided with a function of correcting the plans in accordance with request from the side of the organization.

The dispatch personnel capability acquiring means 57 forms capability data with regard to personnel who desire to register by a processing similar to that in FIG. 29 by using the assessment data table 49 and the capability amount determination table 50 of the data base unit 2. The dispatch personnel registering means 58 forms registered data corresponding individual information such as names of personnel to the capability data and holds thereof at the region 51 of the data base unit 2.

The dispatch personnel sampling means 60 searches the region 51 of the data base unit 2 by being provided with the personnel dispatch plan determined by the plan determining means 59 and samples registered personnel having capabilities in accordance with the personnel dispatch plan.

The yield setting means 55 includes capability amount acquiring means 61, second comparing means 62, yield converting means 63 and yield presenting means 64. These means are operated by a procedure of FIG. 41, mentioned later, and sets yield applied to the organization.

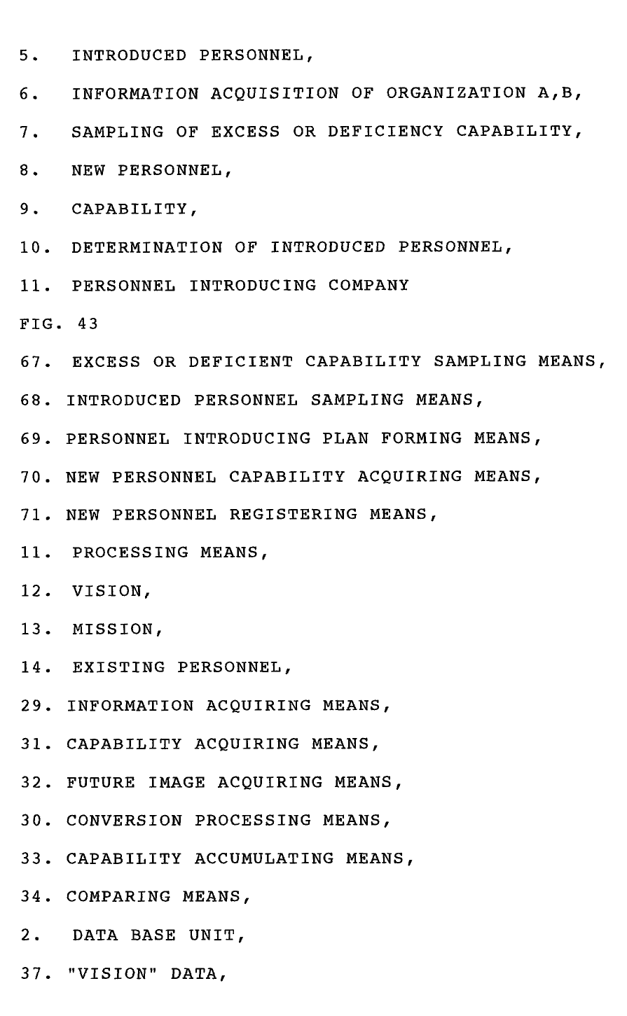

FIG. 40 shows a procedure of a processing by the dispatch personnel sampling means 60.

First, at initial step ST51 of the processing, the excess or deficiency degree data of capabilities in the organization is read from the region 43 of the data base unit 2 and it is checked whether there is a deficient capability. When there is a deficient capability, determination of ST52 is “YES” and in the following, processings of ST53 through ST55 are repeatedly executed until the deficiency of capability is determined to resolve at ST56.

First, at ST53, the region 51 of the data base unit 2 is searched and it is checked whether there is registered a dispatch personnel capable of providing the deficient capability. When the determination is “YES”, the operation proceeds to ST54 and samples registered data of the corresponding personnel. Meanwhile, when determination of ST53 is “NO”, capabilities of unregistered personnel (plural personnel) are assessed and thereafter, personnel in accordance with the deficient capability amount are sampled as dispatch personnel (ST55).

Further, a number of the personnel sampled at ST54 and ST55 is not necessarily single but a plurality of personnel are sampled depending on the deficient capability amount.

When dispatch personnel are sampled for all of deficient capabilities, determination of ST57 is “YES” and at successive ST58, similar to formation of the personnel fostering plan, an output mode of the personnel dispatch plan is selected. Further, at successive ST59, a result of sampling the dispatch personnel is fitted to a template of the selected mode and electronic data of the personnel dispatch plan is formed and outputted to the presenting means 28.

FIG. 41 shows a flow of processings by the yield setting means 55.

In the drawing, at initial processing ST60, the capability amount acquiring means 60 reads the old accumulated capability amount data formed at a time point of starting service and the new accumulated capability amount data provided by the capability accumulating means 33 from the regions 42 and 53 of the data base unit 2. Next, at ST61, by comparing the new and the old accumulated capability amounts for respective kinds of capabilities by the second comparing means 62, degrees of promoting respective capabilities are sampled. At successive ST62, by fitting the degrees of promoting the capabilities to the yield table 54 of the data base unit 2 by the yield converting means 63, the degrees of promoting thereof are converted into a predetermined amount of “yield”. Further, at successive ST63, the yield presenting means 64 forms electronic data for presenting the yield in a form of a debit note to the organization and outputs the data to the presenting means 28.

### \mathring{3} Example 3

### Personnel Introducing System

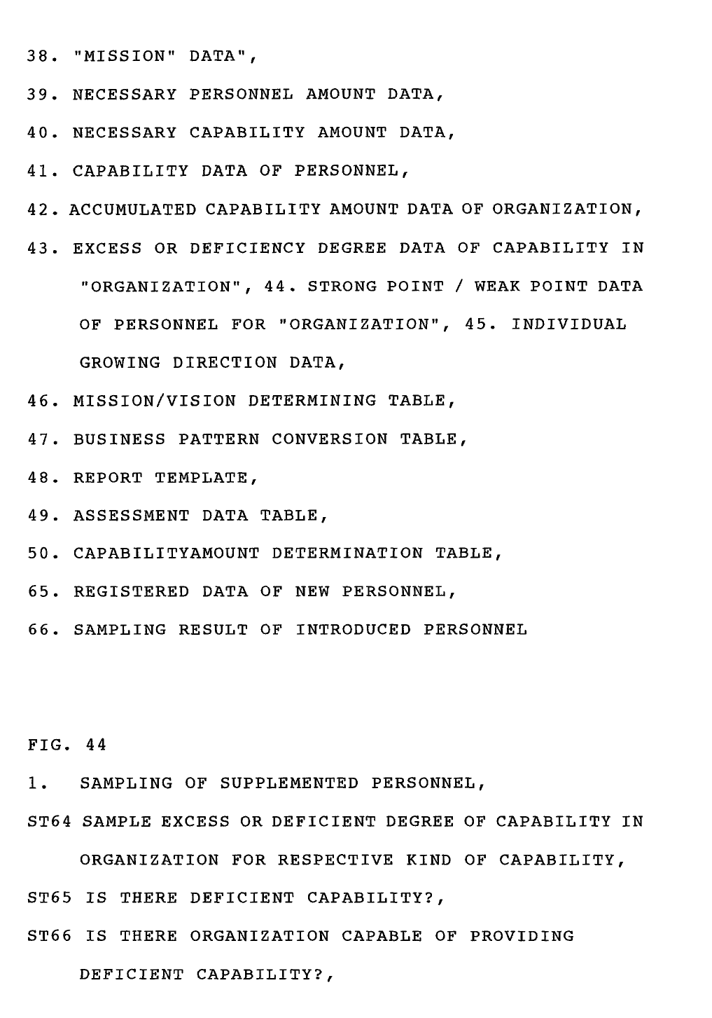

FIG. 42 shows a relationship between a personnel introducing company introducing a personnel introducing system according to the invention and an organization.

The personnel introducing company according to the example acquires information with regard to missions and visions of organizations respectively from the plurality of organizations (in the illustrated example, two organizations A and B are shown), acquires information with regard to capabilities of existing personnel of the respective organizations and samples excess or deficiency degrees of capabilities necessary for executing the missions and the visions in the respective organizations. Further, it is determined whether it is possible to supplement capabilities deficient for one organization from other organization from excess or deficiency degrees of the respective organizations. Further, when this is possible, supplementary personnel are extracted from the latter organization and introduced to the former organization. Further, there also is a case of proposing to exchange personnel between the two organizations based on the excess or deficiency states of capabilities of the respective organizations as shown by dotted lines in the drawing.

Further, a new personnel in FIG. 42 is a personnel registered as a personnel for supplement by the personnel introducing company and when the personnel for supplement to a predetermined organization is not found, the personnel introducing company introduces a registered personnel having a capability in accordance with the personnel for supplement.

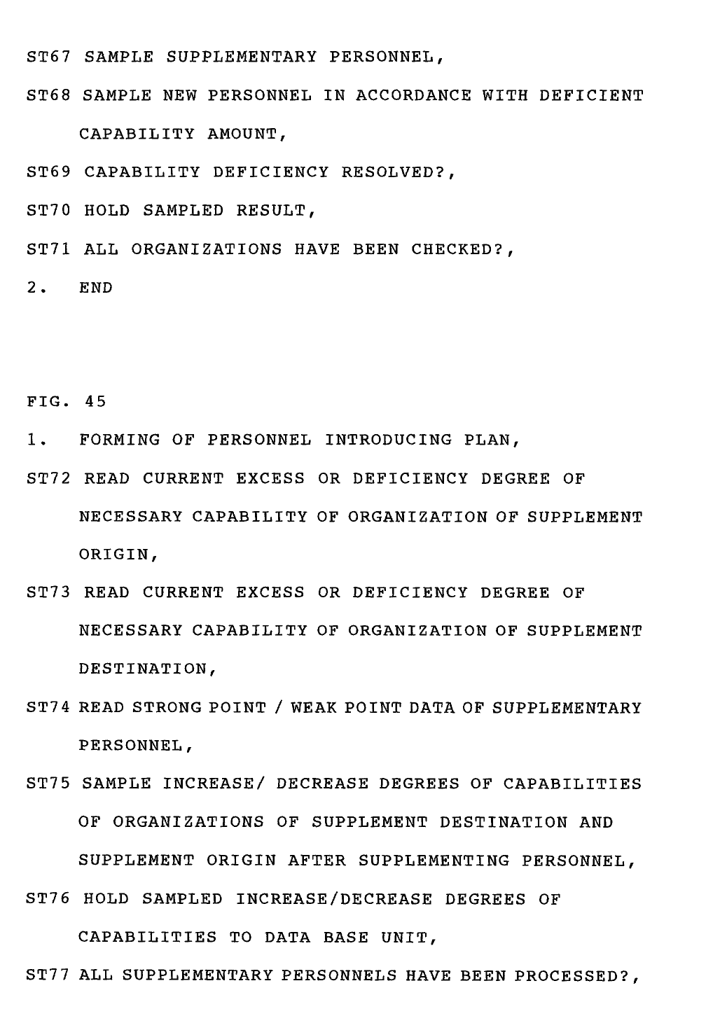

FIG. 43 shows a specific constitution of the personnel introducing system. Further, although the system is a specific example of the personnel supplementing system shown in FIG. 12, a system used by a personnel department of a company for determining a policy of reshuffling personnel is also provided with a substantially same constitution.

Similar to the first and the second examples, the system is also constituted by the processing means 1 realized by the operation apparatus 21 and programs and the data base unit 2.

The data base unit 2 is set with storing regions 65 and 66 of registered data of new personnel and a sampling result of introduced personnel other than the data storing regions common to those in the previous two examples. Among respective constitutions of the processing means 1, the information acquiring means 29, the capability acquiring means 31, the future image acquiring means 32, the conversion processing means 30, the capability accumulating means 33 and the comparing means 34 are similar to those in the first and the second respective examples. However, the respective means of the example acquire individually business patterns representing missions and visions of organizations and capability data of existing personnel with regard to the plurality of organizations and the acquired information as well as accumulated capability amounts and excess or deficiency degrees of capabilities in the organizations derived from the acquired information, are stored in the data base unit 2 for respective organization.

Further, the processing means 1 of the example is provided with excess or deficiency capability sampling means 67, introduced personnel sampling means 68, personnel introducing plan forming means 69, new personnel capability acquiring means 70 and new personnel registering means 71.

The new personnel capability acquiring means 70 acquires capability data of outside personnel by a method similar to that of the capability acquiring means 31 or the dispatch personnel capability acquiring means 57 of the second example. The new personnel registering means 71 forms registered data corresponding the capability data to individual information of personnel and holds thereof to the region 65 of the data base unit 2.

The excess or deficiency capability sampling means 67 of the example samples capabilities deficient for the respective organizations and capabilities constituting excess thereof by using a result of comparing the accumulated capability amount and the necessary capability amount by the comparing means 34. The introduced personnel sampling means 68 samples an organization which needs to supplement personnel and personnel introduced to the organization as supplementary personnel based on a sampled result by the excess or deficiency capability sampling means 67. Further, a new personnel may be sampled as the introduced personnel.

The personnel introducing plan forming means 69 forms personnel introducing plans to the organizations which need to supplement personnel by using the result of sampling introduced personnel. The plans are formed by fitting sampled data to a template similar to the personnel fostering plan or the personnel dispatching plan and the formed plans are outputted to the presenting means 28 in an electronic data style.

FIG. 44 shows a detailed procedure of processings in the introduced personnel sampling mean 68.

First, at initial step ST64 of the processing, there is read excess or deficiency degree data of capabilities of an arbitrary organization from the data base unit 2 and excess or deficiency degrees are sampled for respective kinds of capabilities. Further, at successive ST65, it is checked whether there is a capability deficient for the organization in respective capabilities.

When there is a deficient capability, determination of ST65 is “YES” and in the following, there is executed a processing of sampling a personnel for supplement in a loop of ST66 through ST69 until the deficiency in capabilities is resolved.

First, at ST66, it is checked whether there is an organization capable of providing the deficient capability based on data of excess or deficiency degrees of other organization. When the capability is brought into an excess state and excess capability amount corresponds to a capability amount of a single personnel or a predetermined number of personnel, determination of ST66 is “YES”, the operation proceeds to ST67 and samples a personnel in correspondence with the excess capability as a supplementary personnel.

Meanwhile, when there is not a personnel supplementing the deficient capability amount in any of the organizations, the operation proceeds to ST68 and samples a personnel in accordance with the deficient capability from registered data of new personnel. Further, a number of the personnel in this case is not necessarily single but when the deficient amount of the capability is large, a plurality of new personnel are sampled.

When introduced personnel or new personnel have been sampled for all of deficient capabilities, determination of ST69 is “YES”, the operation proceeds to ST70 and holds the sampling result to the region 66 of the data base unit 2.

The data held here are data for identifying organizations to which attention is paid, kinds of deficient capabilities and deficient amounts, organization to which the introduced personnel belongs and data for identifying the personnel and when a new personnel is sampled, in addition to these data, data for identifying the sampled new personnel is held.

In the following, by executing similar processings successively for all of the organizations, personnel supplementing capabilities deficient for the respective organizations are sampled and the processing is finished at a time point at which determination of ST71 is “YES”.

Further, according to the embodiment, when the sampled supplementary personnel is assigned to an organization constituting an object of supplement by the personnel introducing plan forming means 69, it is verified how excess or deficiency states of capabilities when an organization to which the personnel has previously belonged and an organization to which the personnel is newly assigned (hereinafter, referred to as “supplement origin organization”, “supplement destination organization”), are changed and there is formed a personnel introducing plan including a result of the verification.

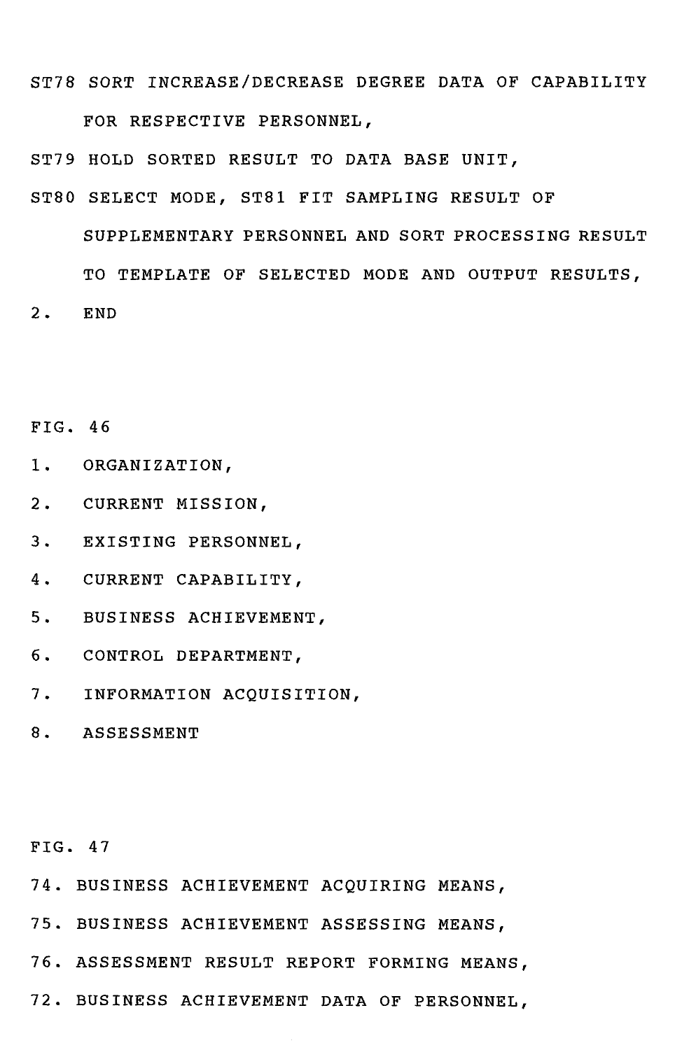

FIG. 45 shows a procedure of forming the personnel introducing plan. Further, the procedure shown here assumes two organizations as an object of the processing, however, a similar method can be adopted when personnel are reshuffled among three or more organizations.

In the drawing, at initial ST72 and ST73, there are read excess or deficiency degrees of current capabilities of organizations from the data base unit 2 respectively with regard to a supplement origin organization and a supplement destination organization.

At successive ST74, there are read strong point/weak point data of supplementary personnel sampled by the procedure of FIG. 44. At successive ST75, respectively with regard to the supplement origin organization and the supplement destination organization, there are calculated excess or deficiency degrees of capabilities after reshuffling the supplementary personnel and increase/decrease degrees of capabilities are sampled by comparing the excess/deficiency degrees with data read at ST72 and ST73. Further, at ST76, a result of sampling is held in the region 66 of the data base unit 2.

When a plurality of supplementary personnel are sampled, the processings of ST74 through ST76 are carried out for respective personnel. When the processings for all of supplementary personnel has been finished, the operation proceeds from ST77 to ST78 and sorts increase/decrease degree data of capabilities provided for the respective personnel. Further, when the increase/decrease degrees of the capabilities are provided for respective kinds of capabilities, by sorting the data with totalized values of the increase/decrease degrees for the respective kinds of capabilities as keys or sorting the data individually for the respective kinds of capabilities, there are provided sorted results of a plurality of ways.

A result of the sorting processing is held at the data base unit 2 at successive ST79.

When data necessary for forming the personnel introducing plan is prepared in this way, at successive ST80, there is selected a mode of the personnel introducing plan. Further, at final ST81, by fitting sorted results of the result of sampling the supplementary personnel and the increase/decrease degree data of capabilities for the respective supplementary personnel to a template of the selected mode, electronic data of the personnel introducing plan is formed and the electronic data is outputted to the presenting means 28.

The personnel introducing plan formed by the above-described processing introduces sampled supplementary personnel respectively to the supplement origin organization and the supplementary destination organization and presents how the excess or deficiency states of capabilities of the respective organizations are changed by reshuffling the personnel among the organizations. Particularly when a plurality of supplementary personnel are sampled, there can be presented a guide line of selecting supplementary personnel optimum for executing current or future missions by the respective organizations.

### \mathring{4} Example 4

### Business Achievement Assessing System

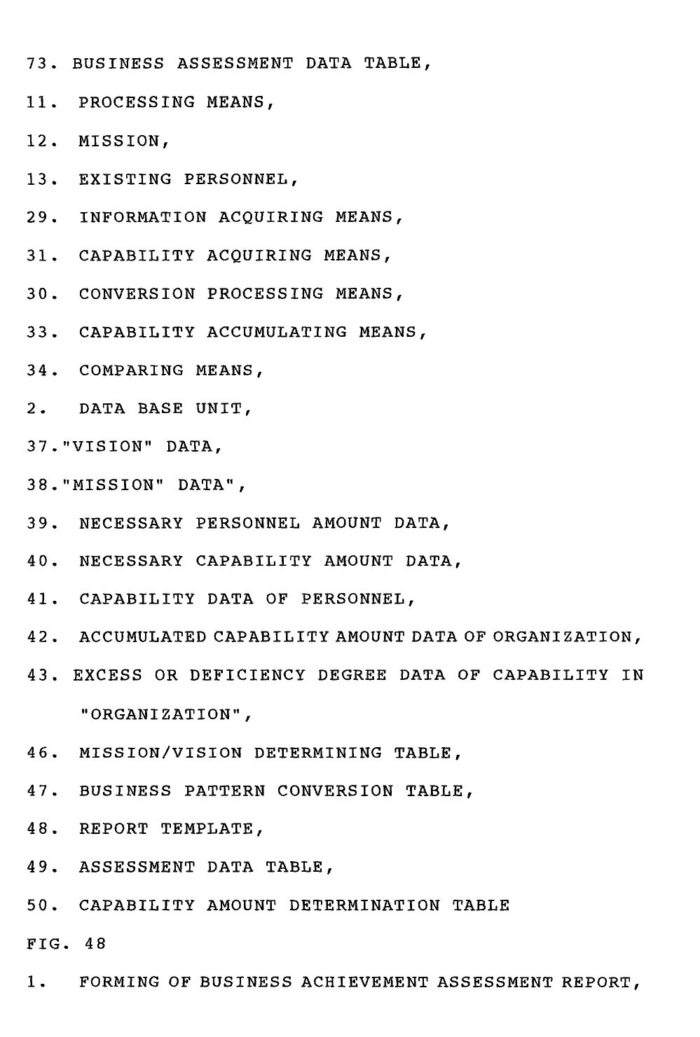

FIG. 46 shows a relationship between a control department using a business achievement assessing system according to the invention and an organization.

The control department acquires information indicating current mission from the organization and acquires information with regard to capabilities and business achievements of respective existing personnel of the organization. Further, based on the information, the business achievements of the respective existing personnel are finally evaluated and informed to the side of the organization.

FIG. 47 shows a specific constitution of the business achievement assessing system.

Similar to the first through the third respective systems, the system is also provided with the processing means 1 by the operation apparatus 21 and programs and the data base unit 2. The data base unit 2 holds a storing region 72 of business achievement data of personnel and a business assessment data table 73 as data particular to the system other than the data storing regions common to the above-described respective examples.

The processing means 1 includes respective means of business achievement acquiring means 74, business achievement assessing means 75 and assessment result report forming means 76 other than the information acquiring means 29, the capability acquiring means 31, the conversion processing means 30, the capability accumulating means 33 and the comparing means 34 similar to those in the respective examples.

The business assessment data table 73 of the data base unit 2 is set with questions for assessing business achievements with regard to a plurality of kinds of business and criteria for determining evaluation values from answer patterns to the respective questions. The business achievement acquiring means 74 deduces a predetermined evaluation value for respective achievement of respective business by a method similar to that of the capability acquiring means 31, that is, a method of presenting respective questions to respective existing personnel or a superior thereof and checking the answer pattern to the respective question with the criteria. Further, there is formed data corresponding items (business items) indicating kinds of business to evaluation values and the data is held in the region 72 of the data base unit 2 as business achievement data.

Meanwhile, by the information acquiring means 29 and the conversion processing means 30, there are calculated necessary capability amounts necessary for executing mission from business patterns indicating the mission of the organization and there is calculated a current accumulated capability amount of the organization by the capability acquiring means 31 and the capability accumulating means 33. The comparing means 34 samples an excess or deficient degree of current capability of the organization by comparing the necessary capability amount and the accumulated capability amount.

The business achievement assessing means 75 forms final business achievement data of respective personnel by inputting business achievement data of respective existing personnel provided by the business achievement acquiring means 74 and the excess or deficient degree of capability provided by the comparing means 34.

The assessment result report forming means 76 forms an assessment result report to the organization or the respective existing personnel by using the final business achievement data. Further, similar to the plans of the above-described respective systems, data for the report is formed by using a template for report of the data base unit 2 and the formed data is outputted to the presenting means 28.

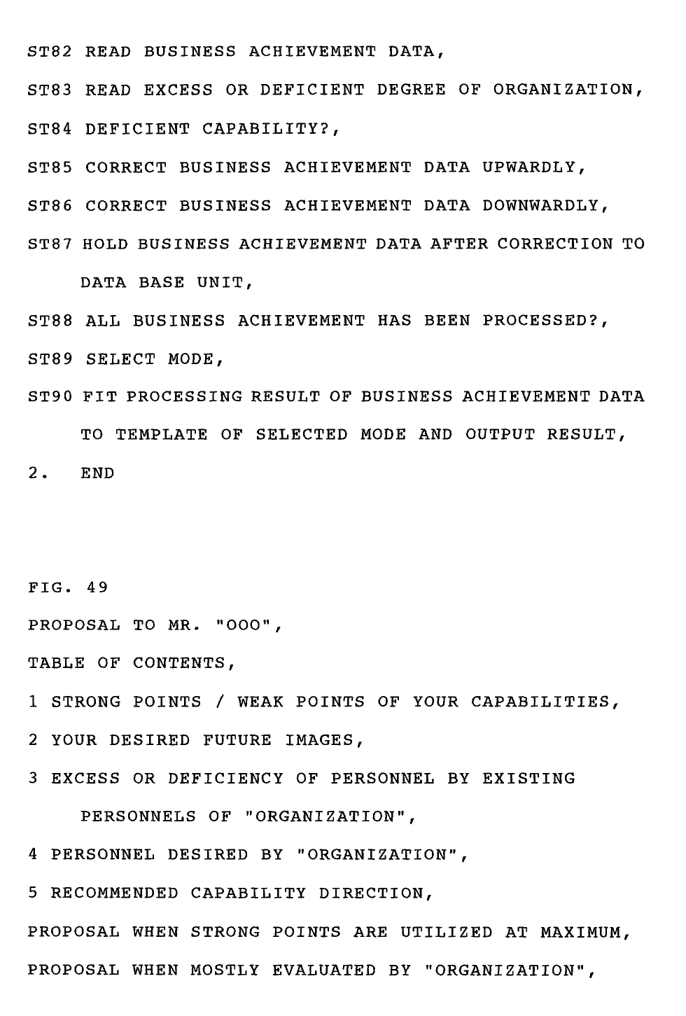

FIG. 48 shows a processing procedure by the business achievement assessing means 75.

First, at initial processing ST82, business achievement data of respective personnel is read from the region 72 of the data base unit 2 and at successive ST83, excess or deficiency degree data of capability of the organization is read from region 43.

In this case, there is constructed a constitution in which the business achievement data is set with evaluation values for respectives of a plurality of business items. At successive ST84 through ST88, the assessment is carried out individually for the respective business items.

At ST84, based on the excess or deficiency degree data of capability, it is checked whether business of an item to which attention is paid is business using a capability deficient for the organization. In this case, when the business is determined to be business using a deficient capability, the operation proceeds from ST84 to ST85 and corrects the evaluation value of the corresponding business upwardly. On the contrary, when the business is determined to be business by a capability not deficient for the organization, the operation proceeds from ST84 to ST86 and corrects the evaluation value of the corresponding business downwardly.

Further, although the evaluation value after correction is held in the region 72 of the data base unit 2 at successive ST87, in this case, it is preferable to hold the evaluation value after correction separately from an original evaluation value of the business achievement.

In this way, an evaluation value higher than normal criteria is set to business which is difficult to execute for the organization and an evaluation value lower than normal criteria is set to business which can be executed simply for the organization.

When the processing with regard to all the business items have been finished, the operation proceeds from ST88 to ST89 and selects a predetermined form similar to that in outputting the plans in the above-described respective examples. Further at ST90, a correction result of the business achievement data provided by ST84 through ST87 is fitted to a template of the selected form, electronic data of a report of the business achievement assessment is formed and outputted to the presenting means 28.

\mathring{5} With Regard to Plan and Report

According to the systems shown in the above-described respective samples, as templates for various plans or reports, by preparing a number of patterned documents or programs, there can be presented further understandable and fuller information to an organization or an existing personnel.

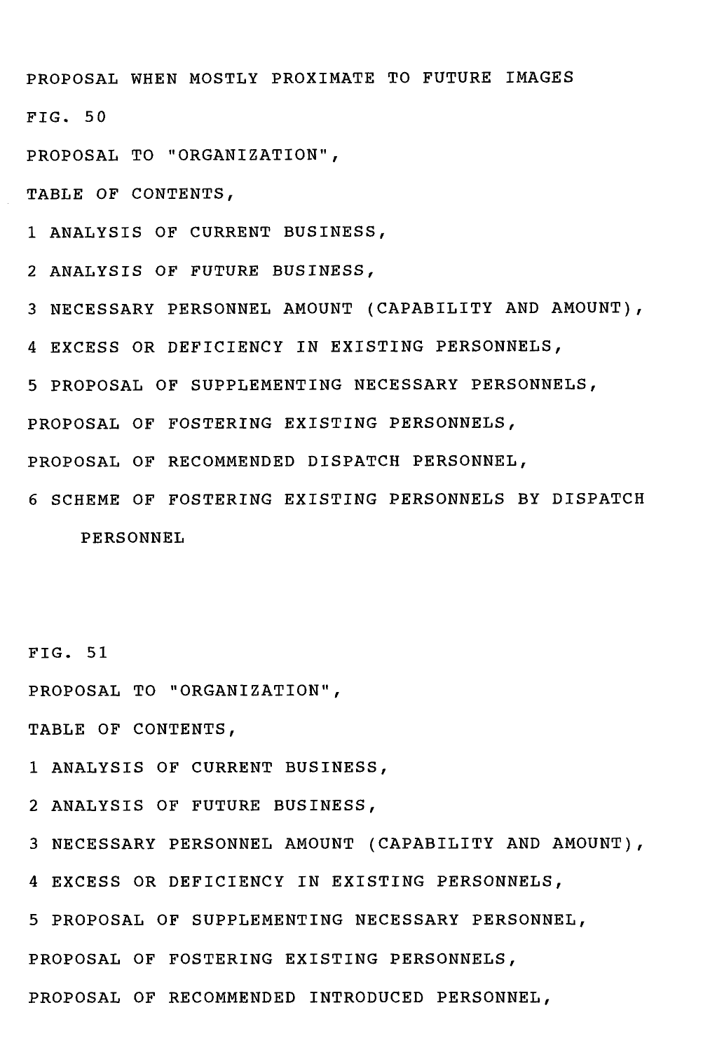

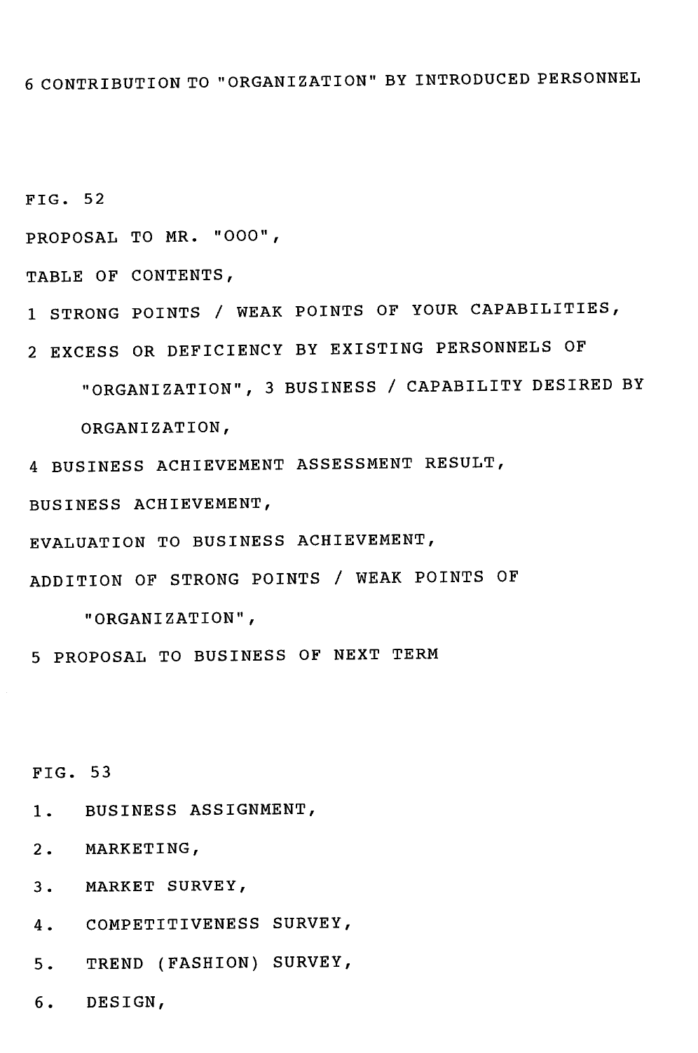

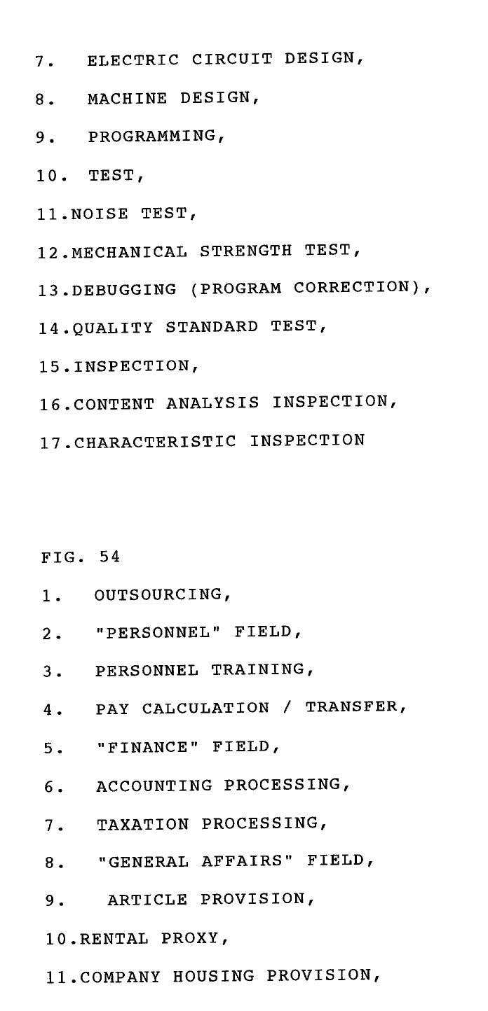

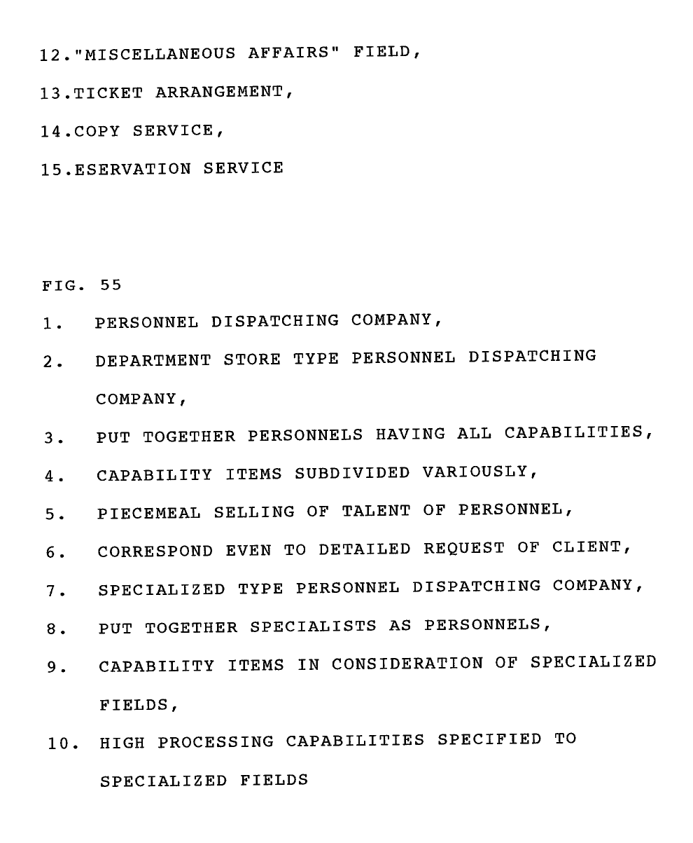

FIG. 49 shows respective output items when the individual plan in the personnel dispatching system of the second example is outputted and FIG. 50 shows respective output items when the personnel fostering plan and the personnel dispatching plan to the organization is summarized into one proposal. FIG. 51 shows output items when the personnel introducing plan is outputted in the personnel introducing system of the third example and FIG. 52 shows output items when a report to the respective personnel is outputted in the business achievement assessing system of the fourth example. Further, although according to any of the illustrated examples, it is assumed to output various information to paper media, in place thereof, as shown by FIG. 26, it is also possible to output the various information to an electronic record medium such as FD, CD-R, DVD. Further, when the organization and the system are connected by a network, an electronic file of respective information may be transmitted via the network. Selection of the output style can be determined by intention of the side of the organization.

According to the aspects of the invention specified by claims 1, 2, 9 and 10, when the plan of fostering the personnel in the organization is formed, the direction of growing the respective personnel is determined in accordance with the excess or deficient state of the capability of the organization with respect to the capability necessary for the organization and the capability held by the respective personnel and therefore, there can be formed the personnel fostering plan effective in executing the mission by the organization by setting the direction of growing the personnel in the direction of promoting the capability particularly deficient for the organization in capabilities provided to the respective personnel.

Particularly when the used information includes the mission of the organization in the future and the capability of the respective personnel anticipated in the future, there can be formed the personnel fostering plan for growing the respective personnel along with growth of the organization by setting the growing direction for promoting the capability deficient for business necessary for the mission of the organization in the future among capabilities of the respective personnel having possibilities of promoting in the future.

According to the aspects of the invention specified by claims 3 and 12, there can be provided a personnel supplementing a capability deficient in executing a mission by the organization and a business service. Further, according to the aspects of the invention specified by claims 4 and 13, there is presented the personnel fostering plan for growing the respective personnel along with growth of the organization to the organization and further, there can be provided a personnel supplementing a capability deficient in executing the mission by the organization at present or supplementing a capability deficient during a time period until the respective personnel in the organization grows in line with the set direction of growing thereof and a service as the supplementary personnel and the business service for the organization and the organization can be supported to grow toward the object.

According to the aspects of the invention specified by claims 5 and 14, a reward sum in accordance with a degree of growing the organization is set to the fostering plan shown to the organization and therefore, proper service can be executed to the organization.

According to the aspects of the invention specified by claims 6, 7, 15 and 16, even with a personnel who is not suitable for a mission of the organization, the personnel can be set as a supplementary personnel of other organization in accordance with capability of the personnel and accordingly, human resource can be utilized by making the respective personnel belong to the organization in accordance with a capability and an aptitude of the respective personnel. Particularly, by carrying out a processing using information with regard to a mission in the future and capability of a personnel in the future, the respective personality can be made to belong to the organization suitable for the capability and the future image of the personnel per se and the organization can be assisted to grow in an ideal direction.

According to aspects of the invention specified by claims 8 and 18, there is formed assessment information using business achievement of the individual personnel and the excess or deficiency degree of the capability of the organization and therefore, there can be carried out an assessment reflecting a contribution degree of the respective personnel with regard to growth of the organization and the respective personnel can properly be evaluated.

There are respectively outputted the personnel fostering plan according to the aspect of the invention specified by claim 11, the report information to the organization for introducing the supplementary personnel from the other organization according to the aspect of the invention specified by claim 17, and the report information indicating the assessment information of the respective personnel according to the aspect of the invention specified by claim 19 and therefore, various plans or report items can be presented to easy to understand to the organization or the respective personnel.

There can be presented to the organization or the respective personnel, information transmitting media outputting the personnel fostering plan according to the aspect of the invention specified by claim 20, the personnel fostering plan and the information for introducing the supplementary personnel according to the aspect of the invention specified by claim 21 and the information for assessing the business achievement according to the aspect of the invention specified by claim 22 respectively by predetermined formats by a computer.

What is claimed is:

1. A method of setting a direction of growing a personnel which is a method of setting a direction of growing a personnel necessary for forming a plan of fostering the personnel in an organization, said method comprising the steps of:
receiving information with regard to a mission of the organization and thereafter deducing a capability necessary for the organization by using the information;
receiving information with regard to a capability of the respective personnel in the organization and thereafter deducing a capability held by the organization by using the information; and
sampling an excess or deficient state of the capability in the organization by comparing a necessary amount of the capability with a capability amount held by the organization for a respective kind of the capability necessary for the organization and thereafter individually setting the direction of growing the respective personnel from the information with regard to the capability of the respective personnel based on a result of sampling thereof.

2. A method of setting a direction of growing a personnel which is a method of setting a direction of growing a personnel necessary for forming a plan of fostering the personnel in an organization, said method comprising the steps of:
receiving information with regard to a current mission of the organization and a mission having a possibility of being given to the organization in the future and thereafter deducing capabilities necessary for the organization at present and in the future by using the information;
receiving information with regard to a capability and a future image of the respective personnel in the organization and thereafter deducing a capability held by the organization and a capability having a possibility of being held by the organization in the future by using the information; and
sampling excess or deficient states of the capabilities in the organization by comparing necessary amounts of capabilities with a capability amount held by the organization and a capability amount having a possibility of being held by the organization in the future for respective kinds of the capabilities necessary for the organization at present and in the future and thereafter individually setting the direction of growing the respective personnel from the information with regard to the capability and the future image of the respective personnel based on a result of sampling thereof.

3. A method of selecting a supplementary capability which is a method of selecting a capability supplemented to an organization, said method comprising the steps of:
receiving information with regard to a mission of the organization and thereafter deducing a capability necessary for the organization by using the information;
receiving information with regard to a capability of a respective personnel in the organization and thereafter deducing a capability held by the organization by using the information;
sampling an excess or deficient state of the capability in the organization by comparing a necessary amount of the capability with a capability amount held by the organization for respective kind of the capability necessary for the organization; and
sampling data in accordance with a deficient state of the capability in the organization from a data base registered with a supplementary personnel having a predetermined capability or a business service executed by the capability.

4. A method of selecting a supplementary capability which is a method of selecting a capability supplemented to an organization, said method comprising the steps of:
receiving information with regard to a current mission of the organization and a mission having a possibility of being given to the organization in the future and thereafter deducing capabilities necessary for the organization at present and in the future by using the information;
receiving information with regard to a capability and a future image of a respective personnel in the organization and thereafter deducing a capability held by the organization at present and a capability having a possibility of being held by the organization in the future by using the information;
sampling excess or deficient states of the capabilities in the organization by comparing necessary amounts of the capabilities with a capability amount held by the organization and a capability amount having a possibility of being held by the organization in the future for respective kinds of the capabilities necessary for the organization at present or in the future and thereafter individually setting a direction of growing the respective personnel from the information with regard to the capability and the future image with regard to the respective personnel based on a result of sampling thereof; and
forming and outputting a fostering plan including information indicating the direction of growing the respective personnel and sampling data with regard to a capability in accordance with a deficient state of the capability in the organization at present and a capability deficient during a time period until the respective personnel in the organization grows in line with the set direction of growing the respective personnel from a data base registered with a supplementary personnel having a predetermined capability or a business service executed by the capability.

5. The method of selecting a supplementary capability according to claim 4:
wherein after elapse of a predetermined time period from outputting the plan of fostering the personnel, a degree of promoting the capability held by the organization is sampled by using information with regard to the capability of the respective personnel at the time point and a reward sum charged to the organization is determined in accordance with the degree of promoting the capability.

6. A method of selecting a supplementary personnel which is method of selecting a personnel supplemented to one organization from other organization, said method comprising the steps of:
receiving information with regard to missions of respective organizations with regard to a plurality of the organizations and thereafter deducing capabilities necessary for the organizations by using the information;
receiving information with regard to respective capabilities of respective personnel belonging to the respective organizations and thereafter deducing capabilities held by the respective organizations by using the information;
determining excess or deficient states of the capabilities in the respective organizations by comparing necessary amounts of capabilities necessary for the respective organizations for respective kinds of the capabilities with capability amounts held by the organizations with regard to the respective organizations; and
sampling a personnel having a capability in the other organization as a supplementary personnel to the one organization when the capability determined to be deficient in the arbitrary one organization is determined to be excessive in the other organization.

7. A method of selecting a supplementary personnel which is a method of selecting a personnel supplemented to one organization from other organization, said method comprising the steps of:
receiving information with regard to current missions of respective organizations and missions having possibilities of being given to the organizations in the future with regard to a plurality of organizations and thereafter deducing capabilities necessary for the organizations at present and in the future by using the information;
receiving information with regard to capabilities and future images of respective personnel belonging to the respective organizations and thereafter deducing capabilities held by the respective organizations at present and capabilities having possibilities of being held by the respective organizations in the future by using the information;
determining excess or deficient states of the capabilities in the respective organizations by comparing necessary amounts of capabilities necessary for the respective organizations at present and in the future with capability amounts held by the organization and capability amounts having possibilities of being held by the organizations in the future for respective kinds of the capabilities with regard to the respective organizations; and
sampling a personnel having a capability in the other organization or a personnel having a possibility of having the capability as a supplementary personnel to the one organization when the capability determined to be deficient at present or in the future in the arbitrary one organization is determined to be excessive at present or in the future in the other organization.

8. A method of evaluating a personnel which is a method of forming assessment information of evaluating a personnel in an organization, said method comprising the steps of:
receiving information with regard to a mission of the organization and deducing a capability necessary for the organization for the mission;
receiving information with regard to a capability of a respective personnel belonging to the organization and deducing a capability held by the organization by using the information;
determining an excess or deficient state of the capability in the organization by comparing a necessary amount of the capability with a capability amount held by the organization for respective kind of the capability necessary for the organization; and
receiving information representing a business achievement of the respective personnel and thereafter forming the assessment information of the respective personnel based on the information and the excess or deficient state of the capability in the organization.

9. A system of forming a personnel fostering plan which is a system of forming a personnel fostering plan of a personnel in an organization, said method comprising:
information inputting means for receiving information with regard to a mission of the organization and information with regard to a capability of a respective personnel belonging to the organization;
necessary capability acquiring means for deducing a capability necessary for the organization for the mission by using the input information with regard to the mission of the organization;
individual capability acquiring means for deducing the capability held by the respective personnel by using the input information with regard to the respective personnel;
capability amount accumulating means for accumulating a capability amount held by the respective personnel with regard to the capability necessary for the organization for respective kind of the capability;
sampling means for sampling an excess or deficient state of the capability in the organization by comparing a result of accumulating the capability amount provided by the capability amount accumulating means with a necessary amount of the capability necessary for the organization;
growing direction setting means for setting a direction of growing the respective personnel from acquired information by the individual capability acquiring means based on the excess or deficient state of the capability sampled by the sampling means; and
plan forming means for forming a fostering plan indicating the direction of growing the respective personnel set by the growing direction setting means for the respective personnel.

10. A system of forming a personnel fostering plan which is a system of forming a personnel fostering plan of a personnel in an organization, said system comprising:
information inputting means for receiving information with regard to a current mission of the organization and a mission having a possibility of being given to the organization in the future and information with regard to a capability and a future image of a respective personnel belonging to the organization;
necessary capability acquiring means for deducing capabilities necessary for the organization at present and in the future for the missions by using the input information with regard to the missions of the organization at present and in the future;
individual capability acquiring means for deducing a capability held by the respective personnel at present and a capability having a possibility of being held by the respective personnel in the future by using the input information with regard to the respective personnel;
capability amount accumulating means for accumulating a capability amount held by the respective personnel at present and a capability amount having a possibility of being held thereby in the future for respective kinds of the capabilities with regard to the capabilities necessary for the organization at present and in the future;
sampling means for sampling excess and deficient states of the capabilities in the organization by comparing results of accumulating the capability amounts at present and in the future provided by the capability amount accumulating means with necessary amounts of the capabilities necessary for the organization at present and in the future;
growing direction setting means for setting a direction of growing the respective personnel from acquired information by the individual capability acquiring means based on the excess or deficient states of the capabilities sampled by the sampling means; and
plan forming means for forming a fostering plan indicating the direction of growing the respective personnel set by the growing direction setting means for the respective personnel.

11. The personnel fostering plan forming system according to claim 9 or 10, further comprising:
information outputting means for outputting the plan of fostering the personnel formed by the plan forming means to outside.

12. A system of supplementing a personnel which is a system of selecting a personnel supplemented to an organization, said system comprising:
information inputting means for receiving information with regard to a mission of the organization and information with regard to a capability of a respective personnel belonging to the organization;
necessary capability acquiring means for deducing a capability necessary for the organization for the mission by using input information with regard to the mission of the organization;
individual capability acquiring means for deducing a capability held by the respective personnel by using input information with regard to the respective personnel;
capability amount accumulating means for accumulating a capability amount held by the respective personnel with regard to a capability necessary for the organization for respective kind of the capability;
sampling means for sampling an excess or deficient state of the capability in the organization by comparing a result of accumulating the capability amount provided by the capability amount accumulating means with a necessary amount of the capability necessary for the organization;
a data base registered with a predetermined number of supplementary personnel; and
personnel sampling means for sampling a personnel having a capability in accordance with a deficient state of the capability from the data base based on a result of sampling the excess or deficient state of the capability in the organization by the sampling means.

13. A system of supplementing a personnel which is a system of selecting a personnel supplemented to an organization, said system comprising:
information inputting means for receiving information with regard to a mission of the organization at present and a mission having a possibility of being given to the organization in the future and information with regard to a capability and a future image of a respective personnel belonging to the organization;
necessary capability acquiring means for deducing capabilities necessary for the organization at present and in the future for the missions by using input information with regard to the missions of the organization at present and in the future;
individual capability acquiring means for deducing a capability held by the respective personnel at present and a capability having a possibility of being held thereby in the future by using input information with regard to the respective personnel;
capability amount accumulating means for accumulating a capability amount held by the respective personnel at present and a capability amount having a possibility of being held thereby in the future for respective kinds of capabilities with regard to the capabilities necessary for the organization at present and in the future;
sampling means for sampling excess or deficient states of the capabilities in the organization by comparing results of accumulating the capability amounts at present and in the future provided by the capability amount accumulating means with necessary amount of the capabilities necessary for the organization at present and in the future;
growing direction setting means for setting a direction of growing the respective personnel from acquired information by the individual capability acquiring means based on the excess or deficient states of the capabilities sampled by the sampling means;
information outputting means for forming a plan of fostering the personnel indicating the direction of growing the respective personnel set by the growing direction determining means with regard to the respective personnel and thereafter outputting the plan of fostering the personnel to outside;
a data base registered with a predetermined number of supplementary personnel; and
personnel sampling means for sampling a personnel having a capability in accordance with a deficient state of the capability in the organization at present and a personnel having a capability deficient during a time period until the respective personnel in the organization grows in line with the set direction of growing thereof from the data base based on a result of sampling the personnel by the sampling means.

14. The system of supplementing a personnel according to claim 13, further comprising:
accumulated capability amount holding means for holding a result of accumulating the capability amount at present provided by the capability amount accumulating means in a memory;
new capability acquiring means for deducing the capability of the respective personnel at a time point after elapse of a predetermined time period since the plan of fostering the personnel has been outputted by using the information inputting means and the individual capability acquiring means; and
reward sum determining means for accumulating a capability amount indicated by a new capability of the respective personnel provided by the new capability acquiring means for respective kind of the capability, comparing a result of accumulating the capability amount with the accumulated result held in the memory by the accumulated capability amount holding means and determining a reward sum charged to the organization in accordance with a result of comparing thereof.

15. A system of supplementing a personnel which is a system for selecting a personnel supplemented to one organization from other organization, said system comprising:
information inputting means for receiving information with regard to missions of respective organizations and information with regard to capabilities of respective personnel belonging to the organizations with regard to a plurality of the organizations;
necessary capability acquiring means for deducing capabilities necessary for the respective organizations for the missions by using the input information with regard to the mission;
individual capability acquiring means for deducing capabilities held by the respective personnel by using input information with regard to the respective personnel;
capability amount accumulating means for accumulating capability amounts held by the personnel in the respective organizations for respective kinds of capabilities with regard to the capabilities necessary for the respective organizations;
determining means for determining excess or deficient states of the capabilities in the respective organizations by comparing results of accumulating the capabilities of the personnel provided with regard to the respective organizations by the capability amount accumulating means with necessary amounts of the capabilities necessary for the respective organizations; and
personnel sampling means for sampling a personnel having a capability determined to be deficient in the arbitrary one organization by the determining means from the other organization in which the capability is determined to be excessive.

16. A system of supplementing a personnel which is a system for selecting the personnel supplemented to one organization from other organization, said system comprising:
information inputting means for receiving information with regard to missions of the respective organizations at present and missions having possibilities of being given to the organizations in the future and information with regard to capabilities and future images of respective personnel belonging to the respective organizations with regard to a plurality of the organizations;
necessary capability acquiring means for deducing capabilities necessary for the organizations at present and in the future for the missions by using input information with regard to the missions at present and in the future with regard to the respective organizations;
individual capability acquiring means for deducing capabilities held by the respective personnel at present and capabilities having possibilities of being held thereby in the future by using input information with regard to the respective personnel;
capability amount accumulating means for accumulating capability amounts held by the personnel at present and capability amounts having possibilities of being held thereby in the future in the respective organizations for respective kinds of capabilities with regard to the capabilities necessary for the respective organizations at present and in the future;
determining means for determining excess or deficient states of the capabilities in the respective organizations by comparing results of accumulating the capability amounts at present and in the future provided with regard to the respective organizations by the capability amount accumulating means with necessary amounts of the capabilities necessary for the respective organizations at present and in the future; and
personnel sampling means for sampling a personnel having a capability determined to be deficient at present or in the future in the arbitrary one organization by the determining means from the other organization in which the capability is determined to be excessive at present or in the future.

17. The system of supplementing a personnel according to claim 15 or 16, further comprising:
information outputting means for forming report information for introducing the personnel sampled by the personnel sampling means to an organization deficient of the capability and outputting the report information to outside.

18. A business achievement assessing system which is a system of assessing a business achievement of a personnel in an organization, said system comprising:
information inputting means for receiving information with regard to a mission of the organization, information with regard to a capability of a respective personnel belonging to the organization and information with regard to a business achievement of the respective personnel;
necessary capability acquiring means for deducing a capability necessary for the organization for the mission by using input information with regard to the mission of the organization;
individual capability acquiring means for deducing a capability held by the respective personnel by using input information with regard to the respective personnel;
capability amount accumulating means for accumulating a capability amount held by the respective personnel with regard to the capability necessary for the organization for respective kind of the capability:
sampling means for sampling an excess or deficient state of the capability in the organization by comparing a result of accumulating the capability amount provided by the capability amount accumulating means with a necessary amount of the capability necessary for the organization; and
assessment information forming means for forming assessment information for evaluating the personnel from acquired information with regard to the business achievement of the respective personnel based on the excess or deficient state of the capability in the organization.

19. The business achievement assessing system according to claim 18, further comprising:
information outputting means for forming report information indicating assessment information of the respective personnel and outputting the report information to outside.

20. An information transmitting medium which is an information transmitting medium written with information constituting an object by at least either one of an organization and a respective personnel in the organization by a computer system:
wherein in the computer system, after sampling an excess or deficient state of a capability of the organization with regard to a capability necessary for a mission of the organization, a direction of growing the respective personnel is set from information with regard to a capability of the respective personnel based on a result of sampling thereof and said information transmitting medium is constituted by being written with a personal fostering plan formed by using the direction of growing the respective personnel.

21. An information transmitting medium written with information constituting an object by an organization by a computer system:
wherein in the computer system, after sampling an excess or deficient state of a capability of the organization with regard to a capability necessary for a mission of the organization, a direction of growing the respective personnel is set from information with regard to a capability of the respective personnel based on a result of sampling thereof, a supplementary personnel in accordance with a capability deficient in the organization is sampled from a data base and said information transmitting medium is constituted by being written with a personnel fostering plan formed by using the direction of growing the respective personnel and information for introducing the supplementary personnel.

22. An information transmitting medium written with information constituting an object by a respective personnel of an organization by a computer system: wherein in the computer system, after determining an excess or deficient state of a capability of the organization with regard to a capability necessary for a mission of the organization, said information transmitting medium is constituted by being written with information for assessing a business achievement formed by a business achievement of the respective personnel based on a result of determining the excess or deficient state.
